(19) United States
(12) Patent Application Publication
(10) Pub. No.: US 2013/0292879 A1
(43) Pub. Date: Nov. 7, 2013

(54) MOLDING OF MICRON AND NANO SCALE FEATURES

(71) Applicants: Sandeep DISAWAL, Aurora, IL (US); Bjoern ROSNER, Chicago, IL (US); Michael R. NELSON, Libertyville, IL (US)

(72) Inventors: Sandeep DISAWAL, Aurora, IL (US); Bjoern ROSNER, Chicago, IL (US); Michael R. NELSON, Libertyville, IL (US)

(73) Assignee: NanoInk, Inc.

(21) Appl. No.: 13/462,730

(22) Filed: May 2, 2012

(51) Int. Cl. B29C 45/00; B82Y 40/00

(52) U.S. Cl. 264/328.2; 264/328.1; 977/887

(57) ABSTRACT

A method comprises providing a mold comprising a surface with at least one identification region, the at least one identification region comprising at least one identification feature that has a lateral dimension of 100 microns or less; and molding an item from a moldable material using the mold, such that the at least one identification region is transferred to a surface of the item.

### BACKGROUND

Estimates suggest that hundreds of billions of dollars a year are lost on counterfeit goods of one sort or another. Technology to prevent this should be difficult to replicate or simulate; difficult to alter, transpose, or tamper; easily recognizable by user in either overt or covert form; verifiable by manufacturer or issuer; easily applicable to product or document; and/or cost effective. The technology should not, in principle, alter or degrade functional properties of the goods or require approval by regulatory agencies. Durability and flexibility in the technological goods are important, as a general rule.

A review of counterfeiting in pharmaceuticals and its economic effects may be found in, for example, (1) “Counterfeit Pharmaceuticals: Current Status and Future Projections,” A. I. Wertheimer, et al. J. Am. Pharm. Assoc. 43(6) 710-718 (2003), and (2) Chapter 4 of the book Counterfeiting exposed: protecting your brand and your customers, D. M. Hopkins, L. T. Kontnik, M. T. Turnage (Wiley, Ed. 2003); ISBN: 0471269905.

### SUMMARY

Exemplary embodiments are summarized in this non-limiting summary section. Embodiments described herein include methods of making, methods of using, compositions, and devices.

In one aspect, a method is provided comprising providing a pharmaceutical container portion mold comprising a surface with at least one identification region, the at least one identification region comprising at least one identification feature that has a lateral dimension of 100 microns or less; and molding a pharmaceutical container portion from a moldable material using the mold, such that the at least one identification region is transferred to a surface of the pharmaceutical container portion.

In one embodiment, the mold comprises a receptacle and a removable insert, wherein the removable insert is configured to fit in the receptacle, and wherein the removable insert comprises the at least one first surface.

In one embodiment, the at least one first feature has a first height dimension smaller than about 100 microns. The at least one first feature can have a first height dimension smaller than about one micron. The first lateral dimension can be smaller than about one micron.

In one embodiment, the at least one first feature comprises at least one indentation into said at least one first surface. In another embodiment, the at least one first feature comprises at least one protrusion out of said at least one first surface.

In one embodiment, the at least one first feature comprises at least one bar code.

In one embodiment, the moldable material comprises a polymer.

In one embodiment, the pharmaceutical container portion comprises at least one of a vial cap or a syringe portion. The syringe portion can be, for example, the syringe barrel or the syringe plunger.

In one embodiment, the mold comprises a removable insert, the removable insert comprises the at least one first surface, and the method further comprises replacing the insert.

In one embodiment, the first and second features are nanoscale features.

In one embodiment, the first and second features comprise a covert feature or an overt feature.

In another aspect, a mold is provided for injection molding at least a pharmaceutical container portion, wherein said template comprises at least one surface, wherein said at least one surface comprises at least one integral feature with a lateral dimension smaller than about 100 microns.

In one embodiment, the pharmaceutical container portion comprises one of, for example, a vial cap, a bottle, or a syringe.

In one embodiment, the at least one surface is the interior of a vial cap, or bottle, or a syringe.

In one embodiment, the at least one integral feature is a nanoscale feature.

In one embodiment, the at least one integral feature comprises at least one indentation into said at least one surface.

In one embodiment, the at least one integral feature comprises at least one protrusion out of said at least one surface.

In one embodiment, the at least one integral feature comprises at least one bar code.

In one embodiment, the at least one integral feature comprises at least one optically variable device.

In one embodiment, the at least one surface is a surface of a replaceable insert.

In one embodiment, the at least one surface is a surface of a replaceable insert, and wherein said insert is disposed over a side wall or a bottom of said template.

In one embodiment, the mold further comprises a receptacle, wherein said at least one surface is a surface of a replaceable insert, and wherein said insert is configured to be removably coupled to said receptacle.

In another aspect, an insert is provided for a mold for injection molding at least a pharmaceutical container portion, the insert comprising at least one surface, wherein said at least one surface comprises at least one integral feature with a lateral dimension smaller than about 100 microns.

In one embodiment, the integral feature comprises a nanoscale feature.

In one embodiment, the integral feature comprises an overt feature or a covert feature.

In another aspect, a method is provided comprising disposing an adhesive or epoxy material over a pharmaceutical container portion, wherein said pharmaceutical container portion comprises a nanoscale feature; curing said adhesive or epoxy material; and removing the cured adhesive or epoxy material from said pharmaceutical container portion to thereby form a replica having a reverse feature of said nanoscale feature.

In one embodiment, the method further comprises inspecting said reverse feature using optical or scanning electron microscopy imaging.

In one embodiment, the curing comprises UV or thermal curing.

At least one advantage for at least one embodiment is that improved anti-counterfeiting can be achieved.

In one embodiment, a method comprises providing a mold comprising a surface with at least one identification region, the at least one identification region comprising at least one identification feature that has a lateral dimension of 100 microns or less; and molding an item from a moldable material using the mold, such that the at least one identification region is transferred to a surface of the item. The molding is performed using one of the techniques selected from the group consisting of reaction injection molding, compression molding, metal injection molding, thermoforming, co-injection molding, fiber-loaded injection molding, gas-assisted injection molding, and rubber injection molding.

In one embodiment, the mold comprises a removable insert, and wherein the removable insert comprises the surface with the at least one identification region.

In one embodiment, the at least one identification comprises two or more identification regions.

In one embodiment, the at least one identification feature has a height smaller than about 100 microns.

In one embodiment, the at least one identification feature has a height smaller than about 1 micron.

In one embodiment, the at least one identification feature has a height smaller than about 100 nm.

In one embodiment, the lateral dimension is smaller than about 1 micron.

In one embodiment, the at least one identification feature comprises an indentation in the surface of the mold.

In one embodiment, the at least one identification feature comprises a protrusion on the surface of the mold.

In one embodiment, the at least one identification region comprises a barcode.

In one embodiment, the at least one identification region comprises a moiré pattern.

In one embodiment, the moldable material comprises a polymer.

In one embodiment, the item comprises a pharmaceutical bottle, a pharmaceutical vial cap, a syringe barrel, a syringe plunger, a rubber stopper or an inhaler.

In one embodiment, the mold comprises a removable insert, and wherein the removable insert comprises the surface with the at least one identification region, the method further comprising replacing the insert.

In one embodiment, the at least one identification feature is at least one nanoscale identification feature.

In one embodiment, the at least one identification feature is a covert identification feature.

In one embodiment, the molding material is an epoxy.

In one embodiment, the moldable material is a thermoplastic material.

In one embodiment, the moldable material is a thermosetting material.

In one embodiment, the moldable material is a composite material such as a carbon fiber layup with resin or a fiberglass layup with resin.

In one embodiment, the moldable material is a metal.

In one embodiment, the removable insert comprises a die that is disposed within a recess located in a portion of the removable insert, wherein the die comprises the surface with the at least one identification region.

In one embodiment, edges of the die are flush with a surface of the removable insert surrounding the die.

In one embodiment, the surface comprises at least ten of, optionally, the same identification regions or the same identification regions.

In one embodiment, the surface comprises at least 100 of, optionally the same identification regions or the same identification regions.

In one embodiment, the at least one identification region comprises a diffraction grating.

In one embodiment, the diffraction grating is configured to provide a form birefringence effect.

In one embodiment, the diffraction grating is configured to provide an anti-reflection effect.

In one embodiment, the diffraction grating is configured to provide an interference effect.

In one embodiment, moldable material is a transparent material, and the diffraction grating is configured to provide a dot pattern when laser light is shined through the diffraction grating.

In one embodiment, the method further comprises creating a replica of the diffraction grating out of a transparent material, wherein the replica is configured to provide a dot pattern when laser light is shined through the diffraction grating of the replica.

In one embodiment, the diffraction grating is configured to provide a color change when light of a range of wavelengths such as white light is irradiated onto the diffraction grating.

In one embodiment, the at least one feature has a lateral dimension of 10 microns or less.

In one embodiment, the at least one feature has a lateral dimension of 1 micron or less.

In one embodiment, the at least one feature has a triangular cross section.

In one embodiment, the item is a confectionary composition, a CD, a DVD, a microelectronic device, a micro-optic device, a sensor, an automotive device, a medical device, a piece of sports equipment, an aircraft component, an industrial component such as a wind turbine blade, a consumer appliance, or a contact lens.

In one embodiment, a method comprises providing a mold comprising a surface with at least one identification region, the at least one identification region comprising at least one identification feature that has a lateral dimension of 100 microns or less; and injection molding an item from a moldable material using the mold, such that the at least one identification region is transferred to a surface of the item, wherein the injection speed during injection molding is at least 20% lower than a standard injection speed typically used to injection mold the item, and wherein the packing pressure during injection molding is at least 40% lower than a standard packing pressure typically used to injection mold the item.

In one embodiment, the injection speed during injection molding is at least 40% lower than a standard injection speed typically used to injection mold the item.

In one embodiment, the packing pressure during injection molding is at least 60% lower than a standard packing pressure typically used to injection mold the item.

In one embodiment, the packing pressure during injection molding is at least 80% lower than a standard packing pressure typically used to injection mold the item.

In one embodiment, wherein the injection speed during injection molding is at least 40% lower than a standard injection speed typically used to injection mold the item, and wherein the packing pressure during injection molding is at least 60% lower than a standard packing pressure typically used to injection mold the item.

In one embodiment, a method comprises providing a mold comprising a surface with at least one identification region, the at least one identification region comprising at least one identification feature that has a lateral dimension of 100 microns or less; and molding an item from a moldable material using the mold, such that the at least one identification region is transferred to a surface of the item, wherein the molding material is a thermosetting material or a composite material.

In one embodiment, the molding material comprises vulcanizable rubber, a phenol-formaldehyde resin, a fiber reinforced polymer, urea-formaldehyde foam, melamine resin, a polyimide, a cyanate ester, a polycyanurate, or a curable epoxy.

In one embodiment, the molding material is an epoxy.

In one embodiment, the molding material is a UV curable epoxy.

In one embodiment, a method comprises providing a mold comprising a removable insert, wherein the removable insert comprises a die that is disposed within a recess located in a portion of the removable insert, the die comprising a surface with at least one identification region, the at least one identification region comprising at least one identification feature that has a lateral dimension of 100 microns or less; and molding an item from a moldable material using the mold, such that the at least one identification region is transferred to a surface of the item, wherein edges of the die are flush with a surface of the removable insert surrounding the die.

In one embodiment, the molding is injection molding.

In one embodiment, a method comprises providing a mold comprising a surface with at least one diffraction grating, the at least one diffraction grating comprising at least one feature that has a lateral dimension of 100 microns or less; and injection molding an item from a moldable material using the mold, such that the at least one diffraction grating is transferred to a surface of the item.

In one embodiment, the diffraction grating is configured to provide a form birefringence effect.

In one embodiment, the diffraction grating is configured to provide an anti-reflection effect.

In one embodiment, the diffraction grating is configured to provide an interference effect.

In one embodiment, the moldable material is a transparent material, and the diffraction grating is configured to provide a dot pattern when laser light is shined through the diffraction grating.

In one embodiment, the method further comprises creating a replica of the diffraction grating out of a transparent material, wherein the replica is configured to provide a dot pattern when laser light is shined through the diffraction grating of the replica.

In one embodiment, the diffraction grating is configured to provide a color change when light of a predetermined wavelength is irradiated onto the diffraction grating.

In one embodiment, the at least one identification region comprises a logo.

In one embodiment, the at least one identification region comprises a bar code having an overall length of less than 100 microns.

In one embodiment, the at least one identification feature has a lateral dimension of 10 microns or less.

In one embodiment, the at least one identification region comprises a bar code having an overall length of less than 10 microns.

In one embodiment, the at least one identification feature has a lateral dimension of 1 micron or less.

In one embodiment, the at least one identification feature has a triangular cross section.

In one embodiment, a method comprises providing a mold have a surface, the surface comprising: at least one identification region, the at least one identification region comprising at least one identification feature that has a lateral dimension of 100 microns or less, and a plurality of overt features that simulates a natural surface roughness and texture of the mold so as to camouflage the existence of the at least one identification region; and injection molding an item from a moldable material using the mold, such that the at least one identification region and the plurality of overt features are transferred to a surface of the item.

Another embodiment provides a method comprising: providing a mold comprising a surface with at least one identification region, the at least one identification region comprising at least one identification feature that has a lateral dimension of 100 microns or less; and injection molding an item from a moldable material using the mold, such that the at least one identification region is transferred to a surface of the item, wherein the at least one identification feature has a triangular cross section.

### BRIEF DESCRIPTION OF FIGURES

FIG. 1 shows a schematic diagram illustrating a template including an insert used as a mold for injection molding.

FIG. 2 shows an optical image of the covert feature on the adhesive surface.

FIG. 3 is a scanning electron microscopy (SEM) image of the covert logo on the adhesive surface showing features at, for example, a 50-100 micron scale.

FIG. 4 is an SEM image of the forensic feature (barcodes) on the adhesive surface.

FIGS. 5A-5F are SEM images of a UV-cured epoxy replica of an injection molded vial cap, showing visible (i.e., overt) identification regions (in this case, logos), FIGS. 5A-5C showing a plurality of redundant identification regions in the molded vial cap or replica, and FIGS. 5D-5F showing magnified views of a single identification region in the replica.

FIGS. 6A-6C are SEM images of an injection molded vial cap, showing sub-optical (i.e., covert) identifications regions (in this case, 9.8 micron long bar codes with 200 nm wide lines), FIG. 6A showing four redundant identification regions, FIG. 6B showing a single identification region, and FIG. 6B showing a magnified view of several of the individual identification features of the single identification region.

FIGS. 7A-7H, 7J-7N, and 7P-7Q are SEM images of a UV-cured epoxy replica of the identification regions of FIGS. 6A-6C.

FIGS. 8A-8C are SEM images of an injection molded vial cap, showing an identification region (in this case, 49 micron long bar codes), FIG. 8A showing the whole identification region, and FIGS. 8B and 8C showing magnified views of two different identification features within the identification region.

FIGS. 9A-9H, 9J-9N, and 9P-9Q are SEM images of a UV-cured epoxy replica of the identification region of FIGS. 8A-8C.

FIGS. 10A and 10B demonstrate the accuracy of reproduction of an identification region of FIGS. 6A-6C, FIG. 10A showing the original design of the identification region, and FIG. 10B showing the identification region obtained by injection molding.

FIGS. 11A and 11B demonstrate the accuracy of reproduction of an identification region of FIGS. 8A-8C, FIG. 11A showing the original design of the identification region, and FIG. 11B showing the identification region obtained by injection molding.

FIG. 12A is an image of a plurality of injection molded vial caps having identification regions, with runners and gates still attached; FIG. 12B is an image of an injection molded vial cap, where the die used in injection molding was a 1.5×2.0 mm die having features with a triangular cross-section; and FIG. 12C is an image of an injection molded vial cap, where the die used in injection molding was a 1×0.6 mm die having features with substantially vertical sidewall with minimal draft.

FIG. 13 is an SEM image of a portion of a UV-cured epoxy replica of an identification region (in this case, a bar code) located on an injection molded vial cap, where the die used in injection molding was a 1.5×2.0 mm die having features with a triangular cross-section.

FIG. 14 is an SEM image of a portion of a UV-cured epoxy replica of an identification region (in this case, a bar code) located on an injection molded vial cap, where the die used in injection molding was a 1×0.6 mm die having features with substantially vertical sidewall with minimal draft.

FIGS. 15A-15G are SEM images of a various portions of an identification region or regions located on an injection molded vial cap, where the die used in injection molding was a 1.5×2.0 min die having features with a triangular cross-section, and standard injection molding conditions were used (injection speed of 2.5 in/sec, packing pressure of 5000 psi, mold temperature of 70° F.).

FIGS. 16A-16H and 16J are SEM images of various portions of an identification region or regions located on an injection molded vial cap, where the die used in injection molding was a 1.5×2.0 mm die having features with a triangular cross-section, and, during injections molding, the injection speed was 1.0 in/sec, packing pressure was 1000 psi, and mold temperature was 70° F.

FIGS. 17A-17H and 17J are SEM images of various portions of an identification region or regions located on an injection molded vial cap, where the die used in injection molding was a 1.5×2.0 mm die having features with a triangular cross-section, and, during injections molding, the injection speed was 4.0 in/sec packing pressure was 6000 psi, and mold temperature was 120° F.

FIGS. 18A-18H and 18J are SEM images of a various portions of an identification region or regions located on an injection molded vial cap, where the die used in injection molding was a 1×0.6 mm die having features with substantially vertical sidewall with minimal draft, and standard injection molding conditions were used (injection speed of 2.5 in/sec packing pressure of 5000 psi, mold temperature of 70° F.).

FIGS. 19A-19H and 19J are SEM images of various portions of an identification region or regions located on an injection molded vial cap, where the die used in injection molding was a 1×0.6 mm die having features with substantially vertical sidewall with minimal draft, and, during injections molding, the injection speed was 1.0 in/sec, packing pressure was 1000 psi, and mold temperature was 70° F.

FIGS. 20A-20H and 20J are SEM images of various portions of an identification region or regions located on an injection molded vial cap, where the die used in injection molding was a 1×0.6 mm die having features with substantially vertical sidewall with minimal draft, and, during injections molding, the injection speed was 4.0 in/sec, packing pressure was 6000 psi, and mold temperature was 120° F.

FIG. 21 is an image showing several inserts to which dies having identification features may be attached.

FIG. 22 is an image showing an insert with a die attached thereto, where the die includes a plurality of identification features.

FIG. 23 is an image showing an injection molded vial cap that includes a plurality of overt identification regions, created using the insert and die of FIG. 22.

FIG. 24 is an SEM image of the identification features located on the injection molded vial cap of FIG. 23.

FIG. 25 is a schematic drawing showing the use of a diffraction grating for reflective diffraction of white light into colored light.

FIG. 26 is a schematic drawing showing the use of a diffraction grating for transmissive diffraction of laser light into a plurality of diffraction spots.

FIG. 27A is an image of a vial cap having a diffraction grating imprinted thereon, with incorrect illumination for the diffraction effect; FIG. 27B is a magnified image of the diffraction grating of FIG. 27A, with incorrect illumination for the diffraction effect; FIG. 27C is an image of the imprinted vial cap of FIG. 27A, with correct illumination for the diffraction effect; and FIG. 27D is a magnified image of the diffraction grating of FIG. 27C, with correct illumination for the diffraction effect.

FIG. 28A is an image of a vial cap having a diffraction grating imprinted into the rim of the vial cap, with incorrect illumination for the diffraction effect; and FIG. 28B is an image of the imprinted vial cap of FIG. 28A, with correct illumination for the diffraction effect.

FIG. 29A is an image of a vial cap having a diffraction grating imprinted thereon, where the diffraction effect is not visible on the imprinted vial cap itself in any type of light;

FIG. 29B is a magnified view of the diffraction grating of FIG. 29A; FIG. 29C is an image of a transparent replica of a portion of the vial cap of FIG. 29A, with incorrect illumination for the diffraction effect; and FIG. 29D is an image of a transparent replica of a portion of the vial cap of FIG. 29A, with correct illumination for the diffraction effect.

FIG. 30A is an image showing a diffraction pattern produced by shining green laser light through a glass slide placed in front of a transparent replica of an imprinted diffraction grating; and FIG. 30B is an image showing a diffraction pattern produced by shining red laser light through a glass slide placed in front of a transparent replica of the imprinted diffraction grating.

FIG. 31A is an image of an imprinted vial cap having a diffraction grating; FIG. 31B is a magnified image of the diffraction grating of FIG. 31A; and FIG. 31C is an image showing a diffraction pattern produced by shining red laser light through a glass slide placed in front of a transparent replica of the imprinted diffraction grating of FIGS. 31A and 31B.

FIG. 32A is an image of a transparent imprinted vial cap having a diffraction grating; FIG. 32B is a magnified image of the diffraction grating of FIG. 32A; and FIG. 32C is an image showing a diffraction pattern produced by shining red laser light directly through the transparent imprinted diffraction grating on the vial cap of FIGS. 32A and 32B.

### DETAILED DESCRIPTION

All references cited hereinafter are incorporated by reference in their entirety. No admission is made that any of the cited references is prior art.

U.S. provisional application Ser. No. 61/408,539 filed Oct. 29, 2010, U.S. regular application Ser. No. 13/284,727, and International application no. PCT/US2011/058331 are hereby incorporated by reference in their entireties for all purposes.

A need exists to provide for better protection and security against counterfeiting and grey-market trading, particularly for pharmaceuticals. In particular, the technology hurdles become great when feature sizes go from a micro scale regime into a nanoscale regime such as below one micron, and in particular, below 100 nm. In recent years, some advances in lithography have been reported but these advances have not been applied to the identification problems noted above.

Embodiments described herein can be applied to a variety of products including pharmaceutical container portions such as vial caps and syringe components.

### Injection Molding

Injection molding is generally known in the art. For example, U-NICA Global Security Solutions has a technology known as IntraGRAM™ that forms holographic images in plastic parts.

References on stamping and molding include: (i) Harmening Bacher Bley et al. Proceedings IEEE Micro Electro Mechanical Systems 202 (1992), (ii) “Molding of Plastic Components Using Micro-Dem Tools”, Electronics Manufacturing Technology Symposium, Hong Li and Stephen D. Senturia, 1992, pp. 145-149, and (iii) I. Rubin Injection Molding (Wiley, N.Y.) 1992.

One embodiment described herein is a method to form micro and nano scale structures in moldable materials such as polymer materials during the process of injection molding. The molded polymer parts may be items, such as, containers, portions of the containers, pharmaceutical vial caps or disposable syringe components.

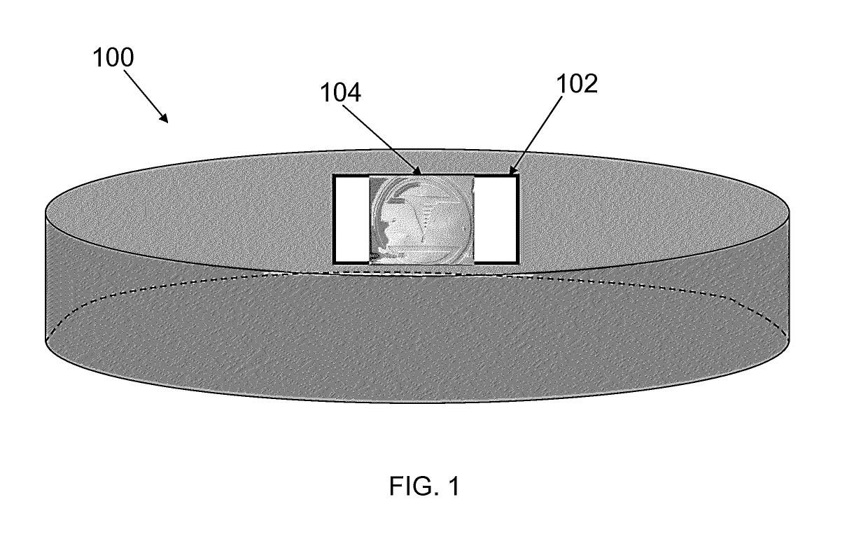

In one embodiment, as illustrated in FIG. 1, a template or mold 100 can include an insert 102 that has micro and nanoscale relief features 104. The insert 102 can be placed at a desired location of the mold 100, such as the side wall, a bottom, an exterior surface, or an interior surface. In some other embodiments, the micro and nanoscale relief features 104 can be formed directly on the mold, such as on a side wall, a bottom, an exterior surface, or an interior surface.

Polymer or other moldable materials can be disposed in the mold 100 during the molding process, such as by injection molding, and the features are formed into the polymer material surface. The molded features can include optically visible identification features, and forensic or sub-optical codes (such as barcodes) that contain alphanumeric data which may be linked to a database of information about the molded component. Information can thereby be imparted to a molded product through the surface structure of the molded product. These features provide strong brand authentication and information for tracking the product in the supply chain. In one embodiment, the features are nanoscale features, and the molded product is referred to as nanoencrypted product.

Nanoencryption may be integrated into existing injection-molded products with existing polymer constituents with few or no changes to the injection molding process conditions. If changes to the injection molding process are required, they would be minor. For example, parameters that may require minor adjustment include use of a higher plastic temperature, longer cool-down time, and/or higher packing pressure.

Also disclosed herein is a method to fabricate a replica containing a reverse structure of the molded feature for product authentication. A UV-curable adhesive was used as the replica material. Overt, covert and forensic features can be transferred to the adhesive surface upon contact with the nanoencrypted product surface. The described method is fast and does not require destruction/waste of the product which in many cases may be expensive. It also does not require the use of elevated temperature (to cure the adhesive) which may be detrimental to many biological reagents.

The assignee of the present application has developed several methods for forming micro and nanoscale features in pharmaceutical dosage units and drug container components. For example, the Nanoencryption process hot embosses structures onto the surfaces of tablets and capsules. This technique is also applicable to a range of polymer materials including those that are normally used in flip-off vial caps and disposable syringe components.

U.S. patent application Ser. No. 12/839,327 (Nano-molding Micron and Nano Scale Features; filed Jul. 19, 2010) describes means to mold features directly into gelatin capsules as they are formed by dipping metal pins in molten gelatin solution, the disclosure of which is hereby incorporated by reference in its entirety. Feature formation can be integrated into the process of forming gelatin capsule shells wherein the capsule forming pins can bear micro and/or nano structures that will get patterned to capsule surface during gelation.

Imprinting methods with stamps and methods of preparing the nanoscale features are described in, for example, U.S. patent application Ser. Nos. 11/109,877 filed Apr. 20, 2005; 11/305,327 filed Dec. 19, 2005; 11/305,189 filed Dec. 19, 2005; and 11/305,326 filed Dec. 19, 2005. See also U.S. Patent Application Pub. No. 2010/0046825.

Embodiments disclosed herein provide other means of forming features into the end product during the normal manufacturing process. For example, the features are formed in the polymer material of the vial cap or syringe portions as the part is injection molded. The syringe portions include, for example, syringe barrels or syringe plungers. This has advantages in terms of cost and throughput by molding during manufacturing as opposed to embossing on the finished part. These features can be used in pharmaceutical brand protection in terms of product authentication and tracking of goods in the supply chain.

### Other Molding Techniques

In addition to typical injection molding, other molding techniques may be used. For example, other possible molding techniques include reaction injection molding, compression molding, metal injection molding, thermoforming, co-injection molding (i.e., “sandwich molding”), fiber-loaded injection molding, gas-assisted injection molding, rubber injection molding, and the like.

### Molding Materials

Materials that can be molded to include identification features include thermoplastic materials, thermosetting materials, composites, and metal. Possible thermoset/composite materials include vulcanizable rubber, Bakelite (polyoxybenzylmethylenglycolanhydride, a phenol-formaldehyde resin), Duroplast (resin plastics reinforced with fibers), a carbon fiber layup with resin, the resin being preferably curable epoxy; a fiberglass layup with resin, the resin being preferably curable epoxy; urea-formaldehyde foam, melamine resin, polyimides, cyanate esters, polycyanurates, and epoxies that can be cured by various means including UV, chemicals, heat, and time. For example, reaction injection molding may be used to mold items having identification features from thermosetting materials.

### Surface Features

The surface of the pharmaceutical container portions can be an exterior surface or an interior surface. The surface of the container portions can be generally smooth, although at the scale of the identification features described herein the surface can be generally rougher. The surface can be non-flat or curved, including spherical, oval, or bi-convex. An interior surface can be desirable to avoid scratching or rubbing of the identification region.

The identification region may comprise one or more features, which protect the information-bearing part from erasure or damage. For example, a raised ring or frame surrounding the identification features may avoid mechanical abrasion of the identification.

The surface of the container portions can comprise non-identification regions and one or more identification regions. An identification region can be an area which is different from the non-identification regions and can have, for example, features for identification (identification features) which are not present in the non-identification regions. Examples of identification regions include bar codes, including for example one-dimensional or two-dimensional bar codes, optionally conforming to the standards of the Uniform Code Council. Other examples include text, symbols, moiré patterns and other engineered patterns that can be clearly interpreted.

In many cases, a full inspection of the identification region may be needed to make the identification. In other words, only inspecting some of the identification features may not give sufficient information to provide adequate identification. For example, if a bar code identification region comprises a series of 10 lines, reading only five of the lines may not give the information needed. The identification region can be characterized by an identification region area which has an enclosing perimeter around the identification features so that all of the identification features can be found within the enclosing perimeter. This area can be for example, about 10,000 square microns or less, or about 1,000 square microns or less, or about 400 square microns or less, or about 4 square microns or less, or about one square micron or less. The identification region can be, for example a square region with a lateral length and width of 100 microns×100 microns, respectively, or 20 microns×20 microns, or 2 microns×2 microns. Or the identification region can be, for example, a generally rectangular region or circular region. In many cases, two or more identification regions are desired in case one or more of the identification regions become unreadable by scratching, rubbing, or some other undesirable event. For example, the surface can comprise more than 20, more than 30, more than 40, or more than 50 identification regions. The identification region can be sufficiently large to be seen by the naked eye or an optical microscope, even when identification features within the identification region can be sufficiently small that they cannot be seen by the naked eye or even with an optical microscope.

Identification generally can enable a recognition. Identification can be also a verification or an authentication. It can encompass both tracing and tracking as well as authentication, including both bar codes and moiré patterns for example.

The identification features are not particularly limited by any shape and can be, for example, dots, circles, lines, rectilinear structures, curvilinear structures, or bar codes, whether linear or radial. Other examples include geometric objects such as, for example, triangles or rectangles. The identification features can be space filling such as, for example, a disk or can be non-space filling such as, for example, a donut or circle with a hollowed out interior. The identification features can form moiré patterns and can be, for example, periodic arrays of lines or dots. The identification features can also form a trademark, service mark, or some other indicia of good will to the customer or branding mark. Dates, names, and other useful commercial information can be provided. In general, the identification features are not complex technological patterns such as a complex circuit pattern. Rather, in general, the function of the identification feature is for identification, not another utility. Generally, it is desired to make the feature as simple as possible while still retaining the function of being an identification feature. For example, bar code technology can be applied at this scale wherein, for example, the width, spacing, and length of lines, and ratios thereof, can be varied to provide information. Preferably, a plurality of identification features can be used and in many cases, only one identification feature is insufficient to provide the needed identification. Preferably, for example, a plurality of linear structures is used in a bar code format.

The identification features can be a positive structure with respect to the surface or a negative structure with respect to the surface. For example, a negative structure can be an indentation, whereas a positive structure can be a protrusion. Hence, for example, a line identification feature could be stamped into a surface to generate an indentation of the line, or a region of a surface could be stamped which resulted in a line protruding from the surface after stamping. Whether positive or negative, the identification feature should be durable and if a positive identification is not sufficiently durable, it can be converted to a negative identification feature.

In general, identification features are preferred which are durable over time. In other embodiments, the identification features can be used to indicate wear, handling, or damage, in which case the identification features may be intentionally formed so as to wear over time. The identification regions and features can be characterized by dimensional measurements such as lateral dimensions or vertical dimensions with respect to the surface. Conventional methods can be used to measure these dimensions including methods described herein and the working examples. Conventional data processing including image processing, pattern recognition, curve fitting and optical character recognition (OCR) can be carried out to provide dimensions and average dimensions and generally to provide useful data.

The identification regions can each have one or more identification features which can be characterized by a lateral dimension with respect to the surface. The lateral dimension can be, for example, a width or a length such as, for example, a circle diameter or a line width, or the relative or absolute position compared to a known mark. The lateral dimension is different from a vertical dimension such as height. For an identification feature which is a line, the lateral dimension of length can be sufficiently long that it can be viewed with the naked eye or an optical microscope, whereas the lateral dimension which is width can be sufficiently small that it cannot be resolved with a naked eye or optical microscope. The size of the lateral dimensions can be sufficiently small so that the identification features are invisible to the naked eye and difficult to detect by conventional, simple methods. Rather, difficult, relatively expensive methods can be used to detect small identification features including microscopic and nanoscopic features. At least one of the lateral dimensions can be made small. For example, the identification feature can have a lateral dimension of, for example, about 500 microns or less, or about 400 microns or less, or about 300 microns or less, or more particularly, about 250 microns or less, or more particularly, about 100 microns or less, or more particularly, about 10 microns or less. Or the identification feature can have a lateral dimension of, for example, about one micron or less, or more particularly, about 500 nm or less, or more particularly, about 250 nm or less, or more particularly, about 100 nm or less. There is no particular limit to how small the lateral dimension can be as long as the identification feature can be detected. For example, the lateral dimension can be at least about 1 nm, or more particularly, at least about 10 nm, or more particularly, at least about 100 nm, or more particularly at least about one micron. Hence, exemplary ranges for the lateral dimension include about one nm to about 500 microns, about 10 nm to about 100 nm, about 100 nm to about one micron, and about one micron to about 500 microns.

For barcodes, the line length is not particularly limited but can vary from nanoscopic to microscopic. For example, lines can be about one micron to about 50 microns long, or about 5 microns to about 25 microns long, and yet have a line width of only about 50 nm to about 200 nm wide.

The identification features can be in the form of a pattern of repeating features such as dots or lines, wherein the features are characterized by an average lateral dimension such as average circle diameter or line width. The lateral size dimensions described herein can be computed into average lateral dimensions.

The identification features can have a vertical dimension such as a height dimension or a depth dimension, and these terms are used interchangeably and for both positive structures and negative structures. The height dimension is not particularly limited and can be, for example, about five microns or less, or about one micron or less, or more particularly, about 500 nm or less, or more particularly about 250 nm or less, or more particularly about 150 nm or less. There is no particular lower limit to the height dimension as long as the identification feature can be detected. The height dimension can be, for example, about one nm or more, or about 10 nm or more, or about 25 nm or more. Exemplary ranges can be, for example, about one nm to about one micron, or about 10 nm to about 500 nm, or about 25 nm to about 250 nm. Again, if a pattern of repeating identification features is used, the vertical dimension can represent an average dimension. The ratio of the depth to the width of the features can be less than 1.

In addition to the lateral dimension and the height dimension, the embodiments disclosed herein can be also characterized by a separation dimension which represents the distance between the identification features such as a separation distance or a pitch. In other words, the one or more identification features can be separated from each other by a particular distance, and this distance can be an average distance for an array of identification features. For example, if the identification features are a series of lines, a distance can be measured between the centers of the lines, or if the identification features are a series of dots, a distance can be measured between the centers of the dots. The distance of separation is not particularly limited but smaller separation distances are preferred so that the identification is invisible to the unaided eye. For example, the one or more identification features can be separated from each other by an average distance of about 500 microns or less, or more particularly, about 100 microns or less, or more particularly, about 10 microns or less, or more particularly, about one micron or less, or more particularly, about 500 nm or less.

### Inserts

An “insert” or a “pin” is a contraption (usually a mechanically robust part) suitable as a carrier for a nanostructured stamp or features and as a mechanical and thermal interface to a mold. Inserts can be used in injection molds to add variable information for a particular lot or batch of product without changing the design of the (usually costly) mold. Examples include serialization or date stamp inserts. In one embodiment, an insert is fabricated in a manner similar to the stamps used for Nanoencryption on the tablet and capsule machines. The insert will have a larger mechanical structure, such as a dieholder, with an embossed die attached. The gate in the injection mold may be located such that the molded material flows over the die during injection, rather than hitting the die straight-on. This configuration allows the molded material to roll over features of the die without creating significant shear, which can dismount the die from the dieholder or cause damage to micro and nanoscale features on the die. Pressure on the features thus increases gradually as the mold cavity become filled and packed. The die may be located far from the gate in the mold (though preferably not on the weld line) and close to the air vents to improve replication quality. The die may extend into the mold cavity, such that the resulting molded product has a nanoencryption feature that is slightly recessed from the surrounding surface, resulting in increased abrasion resistance.

The die may be attached to the insert or pin using epoxy or other adhesives, or using clamps or retaining shims. The inserts or pins may have shallow cut-outs on their ends into which the die may be glued. This can allow for quick exchange of inserts or dies. Alternatively, the die may be magnetically attached to the insert or pin.

Shrinking of the molded product occurs after molding is complete and the product is cooled. In some embodiments, the molded product can easily demold from the die during shrinking such that it can be more easily removed from the mold.

The insert can be replaced for each manufacturing lot of parts that are injection molded. In this way, parts are patterned with micro and nanoscale features similar to those hot-embossed on tablets and capsules during Nanoencryption. All the benefits for brand protection associated with the assignee's tablet and capsules technology are in this way provided on the injection molded parts using the manufacturing process disclosed in the Applicants' prior patent applications.

The insert can be manufactured at low cost and readily exchanged in the molds for batch-level addition of micro and nano scale features. When inserts are used the identification regions to be molded can be rapidly changed, so that it is possible to track items on the batch level. This can make the items more difficult to counterfeit because features at micro and nano length scale are difficult to create and thus provide strong product authentication. Nanoscale features encode alphanumeric information that can be linked to a database of information about the product. Nanoscale codes can be used to track product in the supply chain for purposes of combating counterfeiting and illegal diversion of drugs.

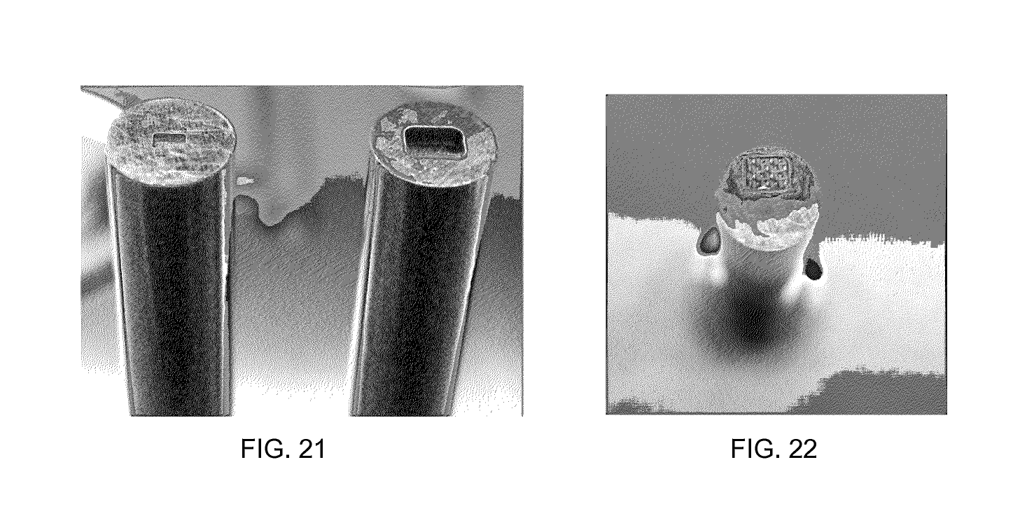

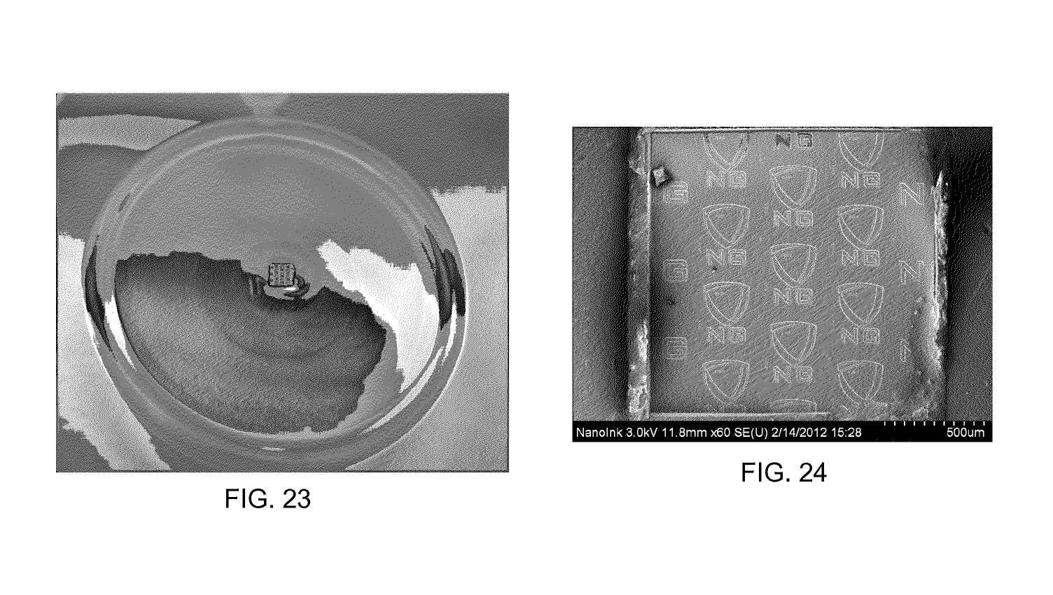

FIG. 21 is an image showing several inserts to which dies having identification features may be attached. FIG. 22 is an image showing an insert with a die attached thereto, where the die includes a plurality of identification features. FIG. 23 is an image showing an injection molded vial cap that includes a plurality of overt identification regions, created using the insert and die of FIG. 22. FIG. 24 is an SEM image of the identification features located on the injection molded vial cap of FIG. 23.

The die may be attached within a recess located in the insert, as shown in FIG. 21. In preferred embodiments, the edge of the die that includes the identification regions is flush (i.e., coplanar) with the surface of the pin, insert, or mold to which it is attached. It other words, the die does not protrude from the pin, insert, or mold. Experiments were performed in which the readability of a plurality of bar codes on an injection molded part were tested while varying the amount by which the die surface (i.e., the surface having the bar codes) extended from a pin. When the die surface extended from the surface of the pin by 0.015 in, only 6% of the bar codes on the resulting injection molded part were readable. When the die surface extended from the surface of the pin by 0.005 in, between 64% and 85% of the bar codes were readable. When die surface was flush with the surface of the pin, between 89% and 98% of the bar codes were readable.

### Replica

The described method can be applied to the situation when the product cannot be directly used for authentication, such as a large size syringe or an expensive vial. Also, some materials/containers, including those that contain liquids, may not be compatible with the vacuum chamber on the SEM which is used for authentication. A replica containing the reverse structures of the molded features on the product can be fabricated for authentication purpose. Epoxy/adhesives are commonly used materials, most of which require elevated temperature for curing. The replica material includes a wide range of UV and thermal curable materials if applicable.

### Pharmaceutical Container Portion

One embodiment of the product is a pharmaceutical container, and pharmaceutical containers are known in the art for a variety of uses, such as holding pharmaceutical capsules or pills. They should also be durable and stable during transport and storage.

The container can be a bottle, a cap, a syringe, etc. The container components can be a side wall, a bottom, or other portions of the container. Security features can be added on vial caps, syringe components and other injection molded components during manufacturing. This is particularly important for the identification of the pharmaceutical content stored in the container.

### Moldable Materials

The methods disclosed herein are applicable to a wide range of polymer materials and injection molded parts. In some embodiments, container components comprise polymer or other moldable materials. Examples of polymers that can be used include polypropylene (including homopolymer type polypropylene), polyethylene (LDPE and HDPE), and polycarbonate. Glass-packed polymers may be used. For storing capsules that are used in a human or animal, the materials for the container should comply with applicable government regulations and not injure the host.

### Templates and Copies

In some embodiments, moldable materials are injected into cavities of templates and allowed to mold. The type of template used will generally depend on the type of injection molding employed. The resulting pharmaceutical container may be referred to as a copy. In some embodiments, the copies are container portions or components.

Molding pins are exemplary of templates used in dip coating. Molding pins suitable for use in a gelatin capsule dip coating process are disclosed in U.S. Pat. No. 4,758,149, which is incorporated by reference in its entirety.

Another example of a template is a mold, such as those used in such molding processes as casting, extrusion blow molding, stretch blow molding, injection molding, and the like. As will be clear to those skilled in the art, many other types of objects could be used as templates.

Template surfaces may be characterized as being substantially convex or substantially concave. An example of a substantially convex template surface is the outward-facing surface of a casting mold. On the other hand, an example of a substantially concave template surface is the inward-facing surface of a casting mold.

The surface of the template may be made of a variety of materials. In general, the surface should be compatible with the moldable material used in the method. It is also desirable that the surface be harder and stiffer than the copy or container product. The surface material may optionally be treated to increase its hardness and durability, if desired. These considerations may be supplemented by others known to those skilled in the art.

Surfaces with Integral Features

In some embodiments, container portions may have surfaces with integral features.

“Integral features” refer to features consisting of the container component material itself, rather than being other applied materials, such as inks or taggants. It will be appreciated by those skilled in the art that by avoiding the use of other materials, regulatory and fitness-for-use requirements may be more easily met. The integral feature can be characterized by an absence of an interface between the feature and the rest of the container portions.

Integral features may be either on an interior or exterior surface of container components.

Surfaces with Small Scale Features

In some embodiments, surfaces may have small scale features. Examples of such features are lines, dots, logos, bar-codes, and optically variable devices, including moiré patterns. A variety of methods may be used to prepare such features. Examples of such methods are described in, for example, U.S. application Ser. Nos. 11/109,877 (filed Apr. 20, 2005), as well as 11/305,327; 11/305,189 and 11/305,326 (all filed Dec. 19, 2005) and these are hereby incorporated by reference in their entireties.

Optically variable devices are described in Lee, R. A., “Optically Variable Devices”, Chapter 7 of Micromanufacturing for Document Security, Mahalik, N. P. ed., Springer, Berlin, 2006, which is incorporated by reference in its entirety.

One type of optical variable device that can be made using the molding nanoscale and microscale molding techniques described herein is a diffraction grating. Diffraction gratings can result in several optical effects, including diffraction/interference effects, and form birefringence effects. Regarding diffraction/interference effects, periodic features can lead to constructive interference for some wavelength and destructive interference for others (dependent on observation angle), leading to a colored appearance of a surface despite the lack of color pigments. It is possible to create the effects with a modulation of index of refraction (also called a hologram). It is also possible to create a structured surface. Anti-reflection can be realized through such a structured surface (rather than using thin-film structures as commonly used for anti-reflection). Anti-reflection can be detected with a bandpass filter and by looking at the magnitude of reflected light.

As for form birefringence effects (i.e., polarization dependence of reflection), for gratings with a few micrometers pitch (for example up to 9 micrometers) and a depth of a few hundred nanometers (for example 600 nm), there can be a >10% magnitude difference between polarization directions (s versus p) which could be enough to be detected in the field. For example, a cell phone with a polarization filter could be used for detection of this difference in polarization directions. Further scaling down the pitch (for example to 400 nm) further increases the polarization-dependent reflection behavior and makes detection easier, while making counterfeiting more difficult. This effect can be used for anti-counterfeiting detection.

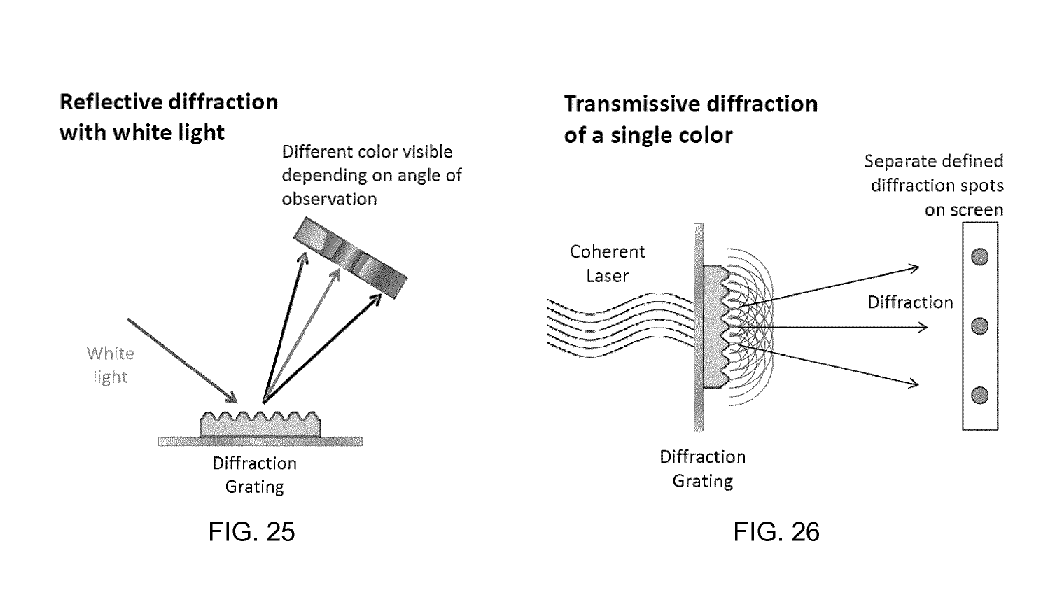

Examples of the optical effects that can be achieved by diffraction gratings are shown in FIGS. 25 and 26. FIG. 25 is a schematic drawing showing the use of a diffraction grating for reflective diffraction of white light into colored light. FIG. 26 is a schematic drawing showing the use of a diffraction grating for transmissive diffraction of laser light into a plurality of diffraction spots.

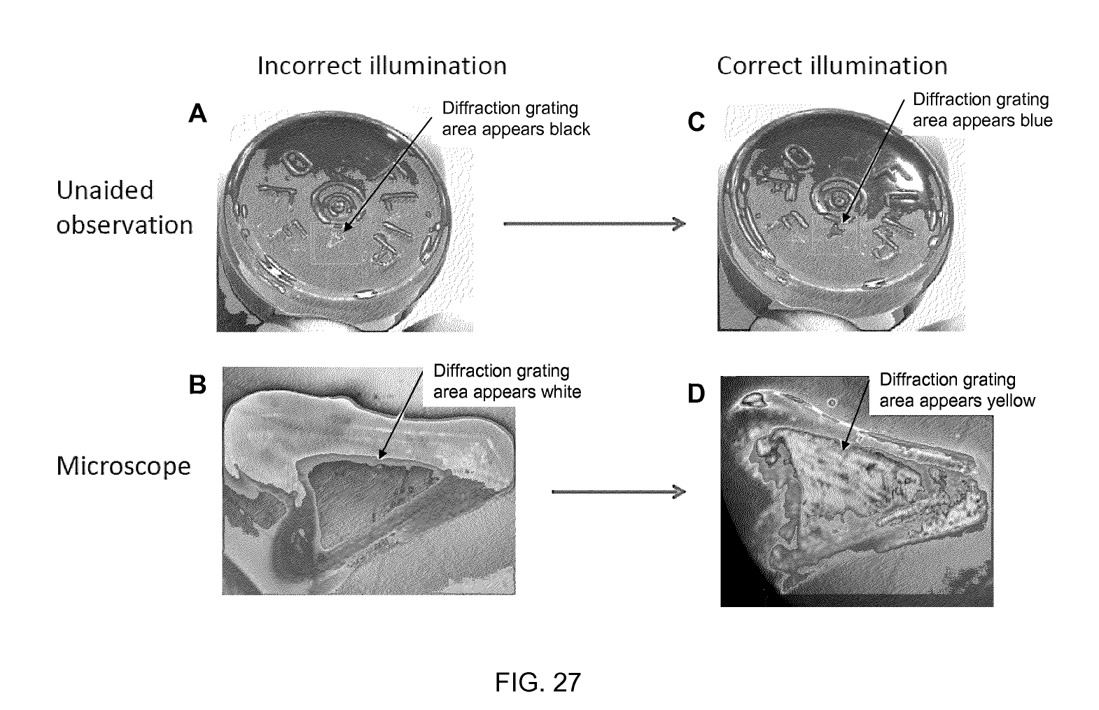

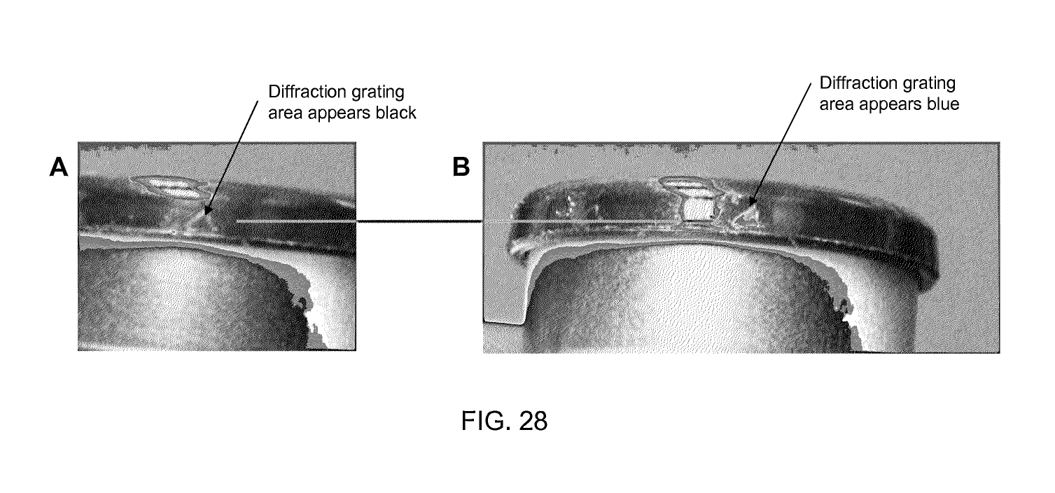

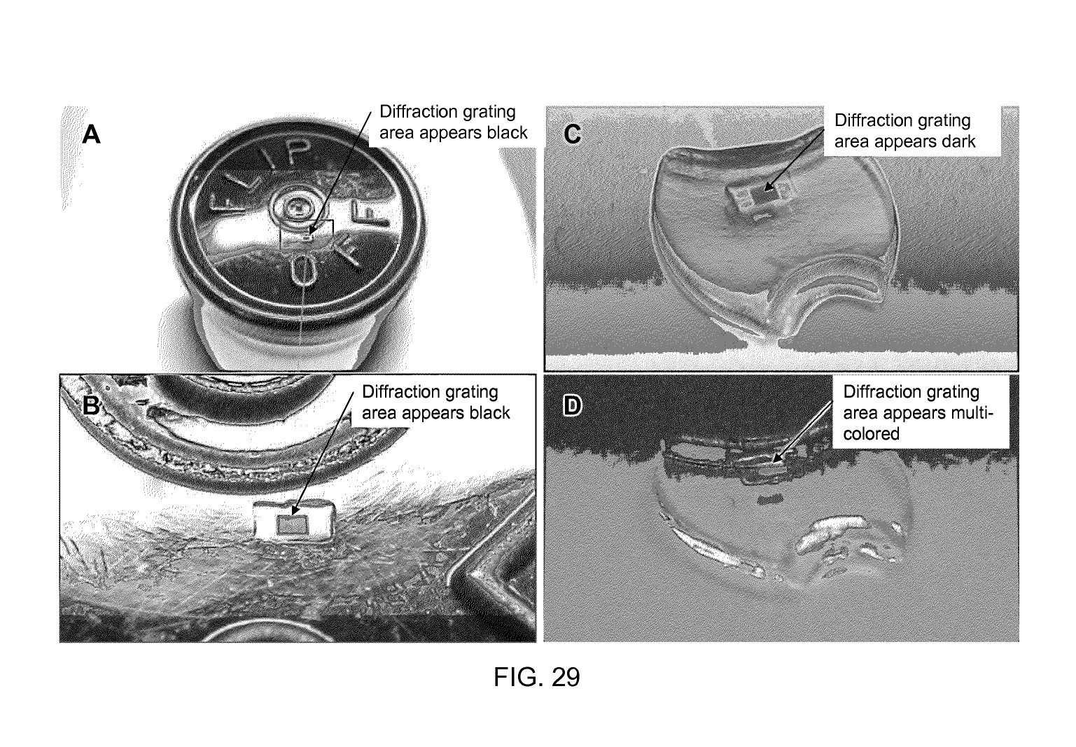

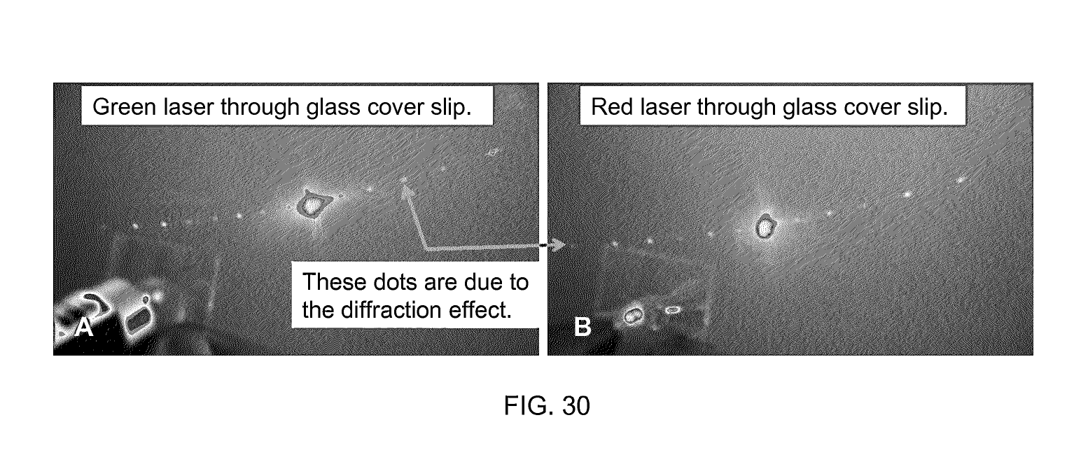

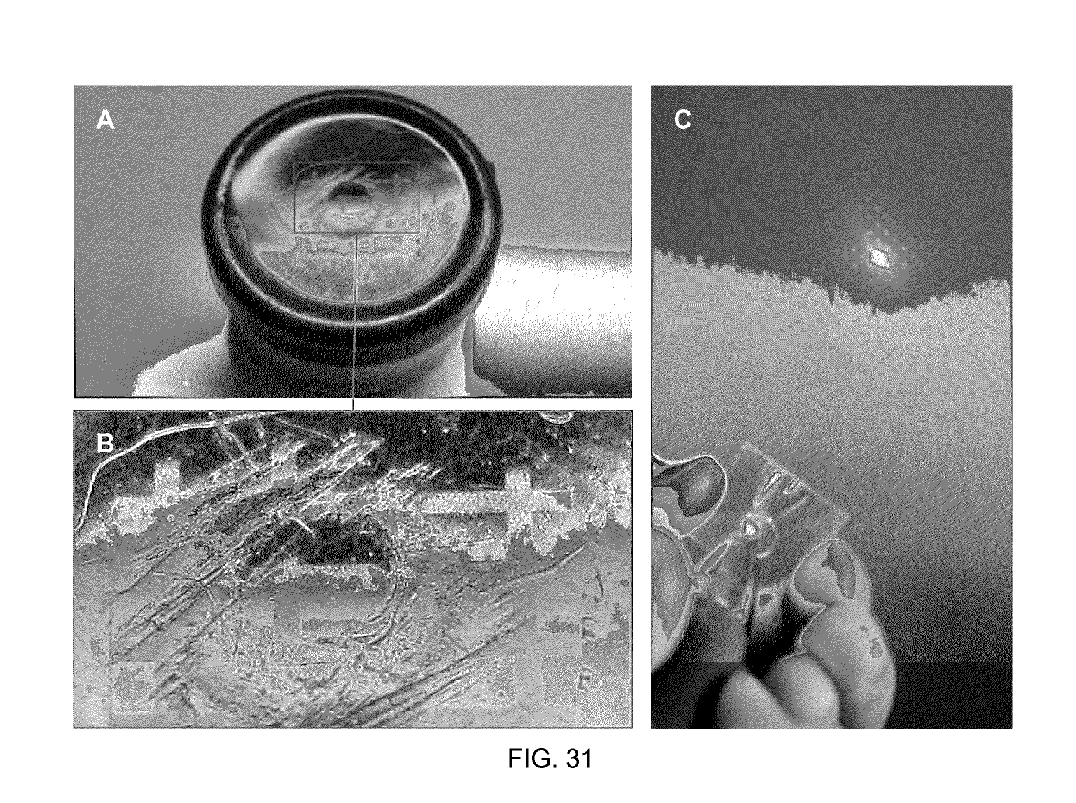

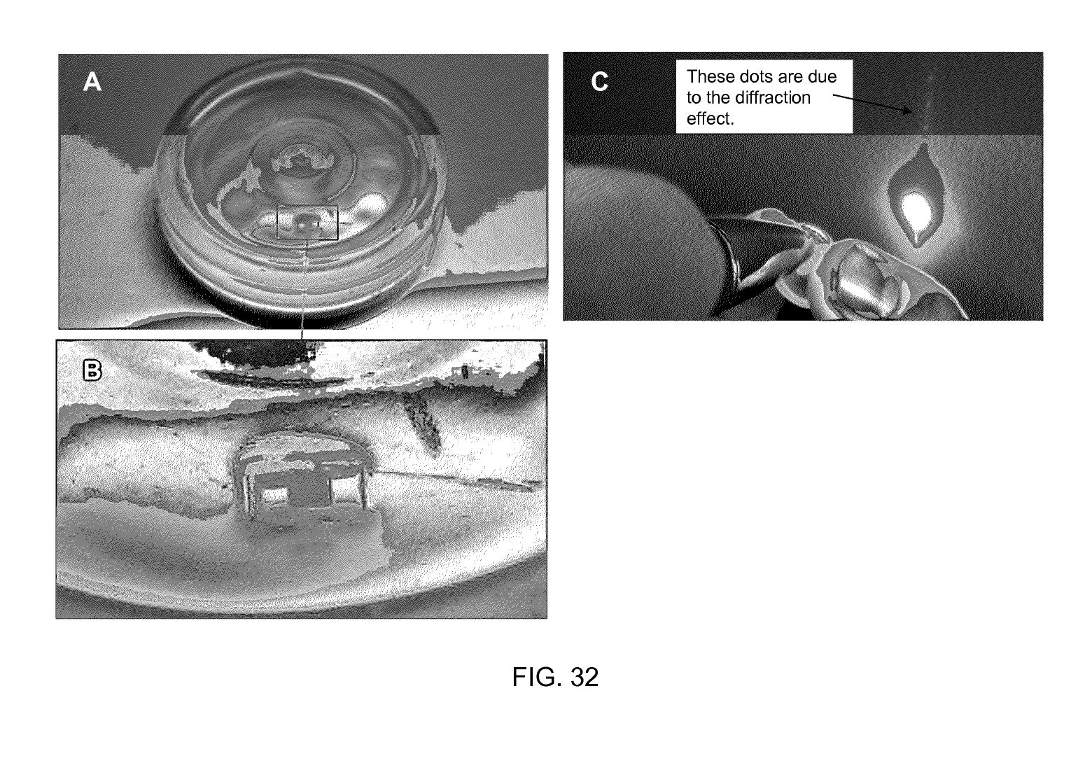

Examples of items created with diffraction gratings are shown in FIGS. 27-32. While the diffraction gratings on these items were imprinted rather than molded, the same results can be achieved using the molding techniques described herein. FIG. 27A is an image of a vial cap having a diffraction grating imprinted thereon, with incorrect illumination for the diffraction effect; FIG. 27B is a magnified image of the diffraction grating of FIG. 27A, with incorrect illumination for the diffraction effect; FIG. 27C is an image of the imprinted vial cap of FIG. 27A, with correct illumination for the diffraction effect; and FIG. 27D is a magnified image of the diffraction grating of FIG. 27C, with correct illumination for the diffraction effect. FIG. 28A is an image of a vial cap having a diffraction grating imprinted into the rim of the vial cap, with incorrect illumination for the diffraction effect; and FIG. 28B is an image of the imprinted vial cap of FIG. 28A, with correct illumination for the diffraction effect. FIG. 29A is an image of a vial cap having a diffraction grating imprinted thereon, where the diffraction effect is not visible on the imprinted vial cap itself in any type of light; FIG. 29B is a magnified view of the diffraction grating of FIG. 29A; FIG. 29C is an image of a transparent replica of a portion of the vial cap of FIG. 29A, with incorrect illumination for the diffraction effect; and FIG. 29D is an image of a transparent replica of a portion of the vial cap of FIG. 29A, with correct illumination for the diffraction effect. FIG. 30A is an image showing a diffraction pattern produced by shining green laser light through a glass slide placed in front of a transparent replica of an imprinted diffraction grating; and FIG. 30B is an image showing a diffraction pattern produced by shining red laser light through a glass slide placed in front of a transparent replica of the imprinted diffraction grating. FIG. 31A is an image of an imprinted vial cap having a diffraction grating; FIG. 31B is a magnified image of the diffraction grating of FIG. 31A; and FIG. 31C is an image showing a diffraction pattern produced by shining red laser light through a glass slide placed in front of a transparent replica of the imprinted diffraction grating of FIGS. 31A and 31B. FIG. 32A is an image of a transparent imprinted vial cap having a diffraction grating; FIG. 32B is a magnified image of the diffraction grating of FIG. 32A; and FIG. 32C is an image showing a diffraction pattern produced by shining red laser light through a glass slide placed in front the transparent imprinted diffraction grating of FIGS. 32A and 32B.

In some cases, lithographic methods may be used, including scanning probe lithography (including DPN printing, nanografting, nanooxidation, and scanning tunneling methods), electron beam lithography, ion beam lithography, laser-based lithography, optical lithography, ultraviolet lithography, X-ray lithography, electron projection lithography, ion projection lithography, low energy electron proximity lithography, forms of lithography involving neutral atoms, grey-tone (relief) microlithography, and the like. Lithographic methods may optionally be used in combination with other processing methods, for example, wet or dry etching, lift-off, substrate doping (including ion implementation), layer deposition, electroplating, electroless plating, polishing, chemical mechanical polishing, and the like. Alternatively, a suitable object may be provided by replicating the features of another object by, for example, stamping, or by molding into a soft material that is subsequently hardened and treated by physical vapor deposition, electroless plating, electroplating, or a combination thereof. These methods may be supplemented by others known to those skilled in the art.

For templates, the surface so prepared may either be an integral part of the template or, optionally, be part of a removable insert that fits into a receptacle in the template or onto the template directly. Such a removable insert could enable the rapid changing of the surface used in the method, as might be required if the small scale features encoded such information as pharmaceutical lot numbers, product identifiers, manufacture dates, and the like.

Small scale features on the surface may be overt or covert. Overt features are those that are typically readily perceived by an observer without unusual technological assistance. Examples of overt features are described in U.S. application Ser. Nos. 11/109,877 filed Apr. 20, 2005, and 11/305,189 filed Dec. 19, 2005, both of which are incorporated by reference in their entireties. Such overt features may be used as means of authentication of objects or compositions of commercial value, such as pharmaceutical items. In such a case, it is preferable that the overt features be visually distinctive and of such a quality that they would be difficult for a counterfeiter to duplicate. Another possible use of such overt features would be to identify brands, models, pharmaceutical lot numbers, product identifiers, manufacture dates, doses, and the like. Overt features that simulate the natural surface roughness and texture of the mold for smooth plastics (i.e. machining grooves, machining finish) could be used to induce a camouflaging effect and counter the shiny appearance that can make the presence of identification regions obvious to the unaided eye.

Covert features are those that are typically difficult to detect, locate, or decode, especially with the naked eye or with conventional inspection technology, such as optical imaging. Examples of covert features are described in U.S. application Ser. Nos. 11/109,877 filed Apr. 20, 2005, and 11/305,326 filed Dec. 19, 2005, both of which are incorporated by reference in their entireties. Such covert features could enable detection of counterfeits without alerting counterfeiters of their presence. They might allow traceability of objects or compositions of commercial value, such as pharmaceutical items, by incorporating such information as pharmaceutical lot numbers, product identifiers, manufacture dates, and the like. Systems for detection of such covert features have been described in U.S. application Ser. No. 11/519,199 filed Sep. 12, 2006, which is incorporated by reference in its entirety.

Small scale features may be characterized by their dimensional measurements. One such dimensional measurement is the small scale feature's height, representing the feature's distance substantially above or below the surface. As used here, a feature's height is always a positive quantity, regardless of whether it lies above or below the surface. The height dimension is not particularly limited and can be, for example, about one micron or less, or more particularly, about 500 nm or less, or more particularly about 250 nm or less, or more particularly about 150 nm or less. There is no particular lower limit to the height dimension as long as the feature can be detected. The height dimension can be, for example, about one nm or more, or about 10 nm or more, or about 25 nm or more. Exemplary ranges can be, for example, about one nm to about one micron, or about 10 nm to about 500 nm, or about 25 nm to about 250 nm. If a pattern of repeating identification features is used, the height dimension can represent an average dimension.

Another such dimensional measurement is the small scale feature's lateral dimension, representing the feature's length or width substantially parallel to the surface. For a feature that is a line, the lateral dimension of length can be sufficiently long that the feature can be viewed with the naked eye or an optical microscope, whereas the lateral dimension of width can be sufficiently small that the feature cannot be so viewed. For applications requiring covert marks, one of these lateral dimensions can be made small. For example, the feature can have a lateral dimension of, for example, about 500 microns or less, or about 400 microns or less, or about 300 microns or less, or more particularly, about 250 microns or less, or more particularly, about 100 microns or less, or more particularly, about 10 microns or less. Or the feature can have a lateral dimension of, for example, about one micron or less, or more particularly, about 500 nm or less, or more particularly, about 250 nm or less, or more particularly, about 100 nm or less. There is no particular limit to how small the lateral dimension can be as long as the feature can be detected. For example, the lateral dimension can be at least about 1 nm, or more particularly, at least about 10 nm, or more particularly, at least about 100 nm, or more particularly at least about one micron. Hence, exemplary ranges for the lateral dimension include, for example, about one nm to about 500 microns, or about 10 nm to about 100 nm, or about 100 nm to about one micron, and about one micron to about 500 microns.

For barcodes, for example, the line length is not particularly limited but can vary from nanoscopic to microscopic. For example, lines can be about one micron to about 50 microns long, or about 5 microns to about 25 microns long, and yet have a line width of only about 50 nm to about 200 nm wide.

Where the small scale features are in the form of a pattern of repeating features, the features can be characterized by a lateral dimension representing an average lateral dimension such as an average circle diameter or an average line width.

Still another such dimensional measurement is the separation distance between small scale features or groups of small scale features. For example, if the features are a series of lines, a distance can be measured between the centers of the lines, or if the features are a series of dots, a distance can be measured between the centers of the dots. The distance of separation is not particularly limited, but smaller separation distances are preferred where it is desired that the features be covert. For example, one or more features can be separated from each other by an average distance of about 500 microns or less, or more particularly, about 100 microns or less, or more particularly, about 500 nm or less.

Yet still another such dimensional measurement is the size of the area of the smallest perimeter that could contain all of the members of a group of small scale features. This area can be, for example, about 10,000 square microns or less, or about 1,000 square microns or less, or about 400 square microns or less, or about 4 square microns or less, or about one square micron or less. Or the features can be, for example, in a square region with a lateral length and width of 100 microns×100 microns, or 20 microns×20 microns, or 2 microns×2 microns, or one micron×one micron. The groups need not, of course, be arranged in a square region. In general, the smallest perimeter might form a circle, a polygon, or some smooth or irregular closed shape.

As will be clear to those skilled in the art, it is possible for a surface to have many features that have a wide-range of dimensions. On can use one or more larger features in combination with one or more small scale features.

Fabrication Methods for the Mold with Micron or Nano Scale Features

E-beam direct-write lithography can be used to generate the microscopic or nanoscale features on the mold or insert. E-beam direct-write lithography is adapted to lithography at very high resolution and is flexible, since it does not require a mask. Electron Beam lithography equipment may be purchased from Raith Gmbh (Dortmund, Germany), Leica Microsystems Inc. (Chantilly, Va.) or JEOL USA (Peabody, Mass.). E-beam lithography services are available from Rockwell Scientific (Thousand Oaks, Calif.). Resists adapted to electron-beam lithography are commercially available, e.g., from Zeon Corp., Toray Corp. (both of Tokyo, Japan) and MicroChem (Newton, Mass.). Electron-beam lithography may be practiced with the help of the following literature, which are hereby incorporated by reference:
1) “Patterning of Material Layers in Submicron Region”, U.S. Tandon, W. S. Khokle, Wiley, Ed.; 1994.
2) A. N. Broers, J. M. Harper, and W. W. Molzen, Appl. Phys. Lett. 33, 392 (1978)
3) P. B. Fischer and S. Y. Chou, Appl. Phys. Lett. 62, 2989 (1993)
4) Y. Chen, A. Pepin, Electrophoresis 22, 187-207 (2001).

In addition, it is known in the art that stamps used in nanoimprint lithography and related techniques are usually fabricated using e-beam lithography, see e.g., “Template for room temperature, low pressure micro- and nano-imprint lithography”, U.S. Pat. No. 6,696,220 to Bailey et al. Electron-beam lithography techniques have been used to produce optically variable devices for use as anti-counterfeiting devices, see e.g., “Micro-technology for anti-counterfeiting”, Microelectronic engineering 53(1-4):513-516 (2000) and references herein.

Microfabrication techniques other than scanning probe lithography, electron-beam lithography and extreme UV lithography can be employed to prepare the features on the mold or insert. Lithographic methods under consideration include but are not limited to optical lithography (including immersion lithography, Deep Ultraviolet (DUV) lithography and Vacuum Ultraviolet (VUV) lithography), focused ion beam lithography (FIB), X-ray lithography, electron and ion projection lithography (EPL and IPL), including SCAPEL and PREVAIL, low energy electron proximity projection lithography (LEEPL), forms of lithography involving neutral atoms, and grey-tone (relief) microlithography.

The lithography step may be optionally combined with (i) one or more process steps including in a non-limiting way wet or dry etching, lift-off, substrate doping (including ion implementation), layer deposition, electroplating, electroless plating, (ii) zero or more planarization steps, including polishing, chemical mechanical polishing and overcoating with a thick layer. This includes processes such as Lithographie-Galvanoformung-Abformung (LIGA) and its optical lithography equivalent (UV-LIGA), see, e.g., “Microprocessing at the fingertips”, G. Thornell, S. Johnansson, J. Micromech. Microeng. 8, 251-262 (1998).

The following references may be used to practice the disclosed embodiments and are hereby incorporated by reference:
1) Lithographic imaging techniques, including optical lithography, particle beam lithography, EUV and X-ray have been reviewed by Wallraff and Hinsberg, “Lithographic Imaging Techniques for the formation of nanoscopic features”, G. M. Walraff, W. D. Hinsberg Chem. Rev. 99, 1801, 1999.
2) Nanolithographic techniques, including e-beam lithography, have been reviewed by Marrian et al., “Nanofabrication”, C. R. K. Marrian, D. M. Tennant J. Vac. Sci. Technol. A 21(5), 2003.

### WORKING EXAMPLES

The following non-limiting examples illustrate additional embodiments.

### Example 1

### Logo 1

### Experimental Procedures:

A flip-off vial cap is formed and Nanoencrypted using the injection molding method described above. Next, a thin layer of UV-curable adhesive (e.g., Norland Optical Adhesive 81) is applied on top of the patterned vial cap surface. The vial cap with the adhesive is exposed under a UV lamp (e.g., TL-D 15W BLB SLV) for 90 seconds, at a distance of about ½ inch. The cured adhesive is then peeled off from the vial cap. The reverse structures, as opposed to the features on the vial cap, are transferred to the adhesive surface. Optical and scanning electron microscope (SEM) imaging can then be used to authenticate the features on the adhesive surface.

### Experimental Results:

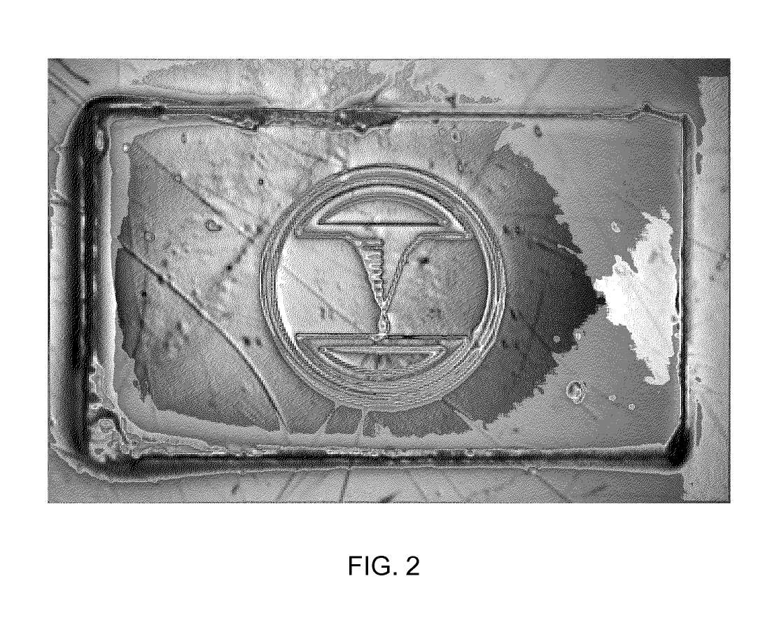

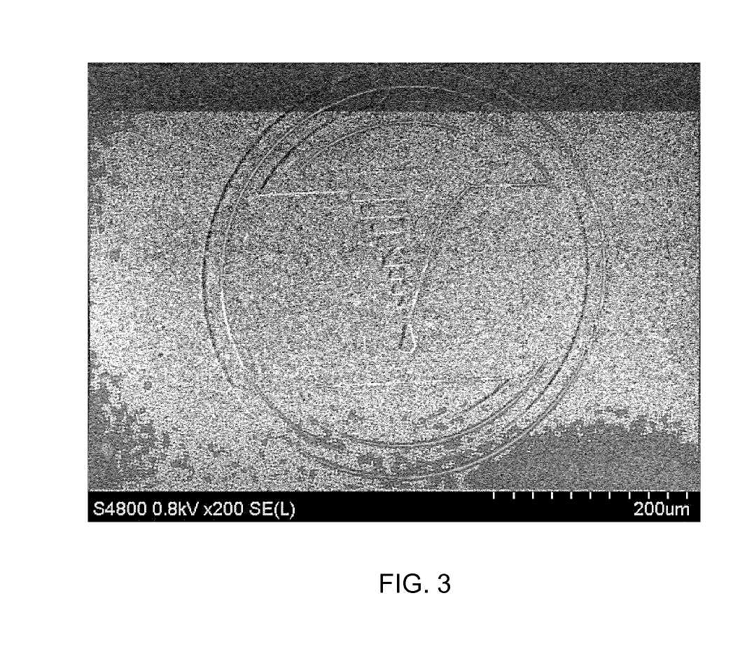

Using nanoencrypted vial cap containing both overt and covert features, the adhesive surface can have the reverse features as shown in the optical image of the covert feature as shown in FIG. 2, or the SEM image of the covert logo at, for example, a 50-100 micron scale, as shown in FIG. 3. FIG. 4 shows the SEM image of the forensic feature (barcodes) on the adhesive surface.

### Example 2

### Logo 2

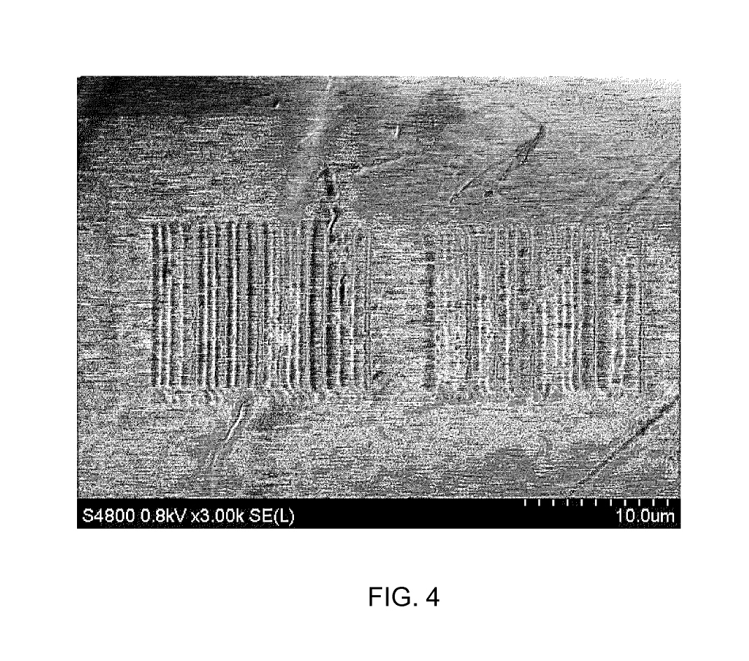

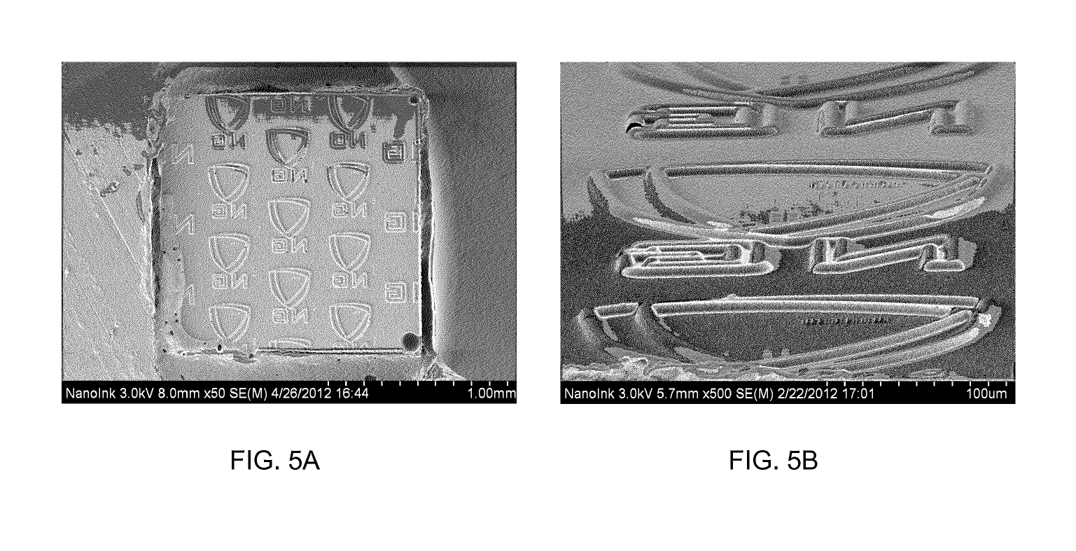

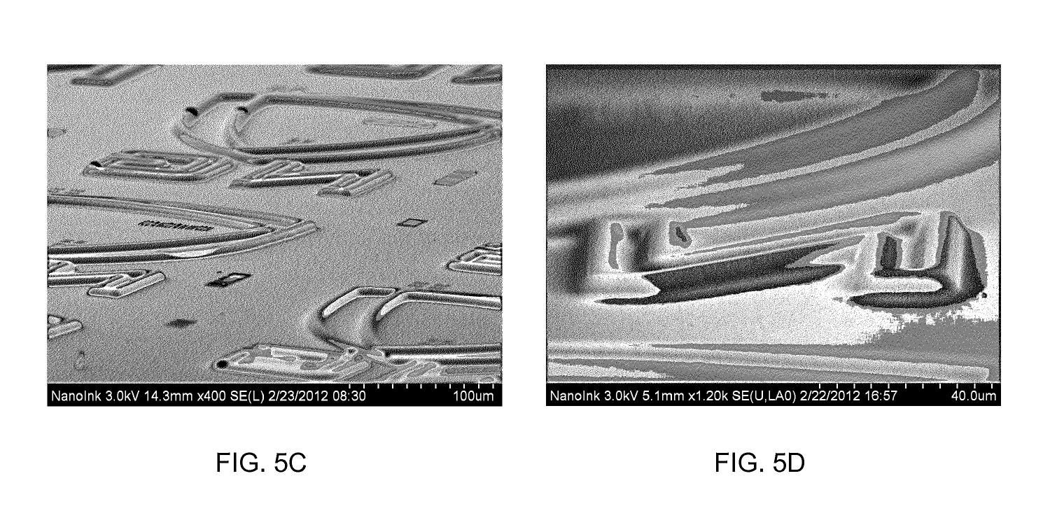

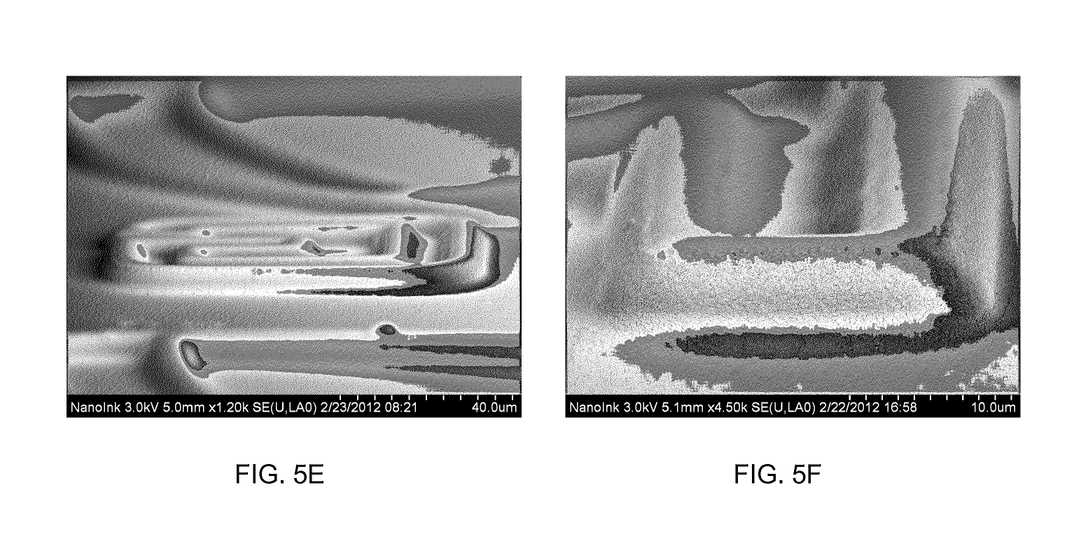

FIGS. 5A-5F are SEM images of a UV-cured epoxy replica of an injection molded vial cap, showing visible (i.e., overt) identification regions (in this case, logos), FIGS. 5A-5C showing a plurality of redundant identification regions in the replica, and FIGS. 5D-5F showing magnified views of a single identification region in the replica. The vial cap was molded using a packing pressure of 5000 psi, injection speed of 2.0 in/sec and mold temperature of 70° F. The identification features are shown to be raised from the surface of the replica. Thus, the vial cap itself contained recessed identification regions.

### Example 3

### Small Bar Codes

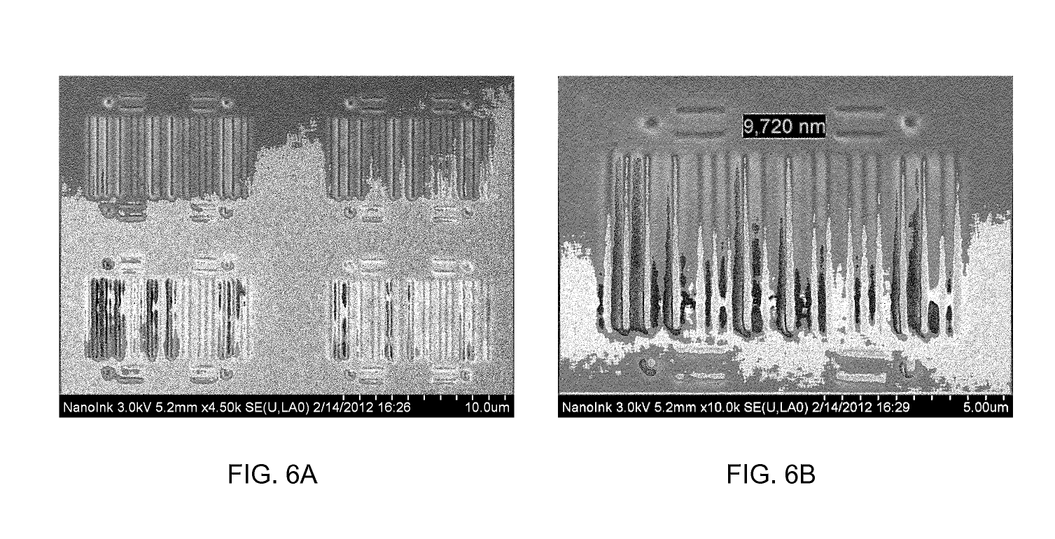

FIGS. 6A-6C are SEM images of an injection molded vial cap, showing sub-optical (i.e., covert) identifications regions (in this case, 9.8 micron long bar codes), FIG. 6A showing four redundant identification regions, FIG. 6B showing a single identification region, and FIG. 6B showing a magnified view of several of the individual identification features of the single identification region. The vial cap was molded using a packing pressure of 5000 psi, injection speed of 2.0 in/sec and mold temperature of 70° F.

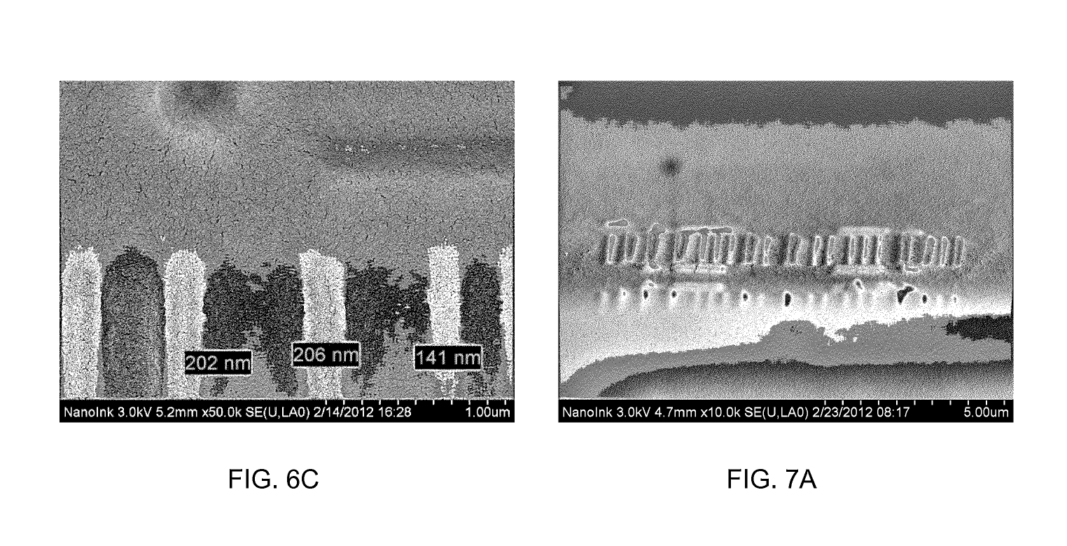

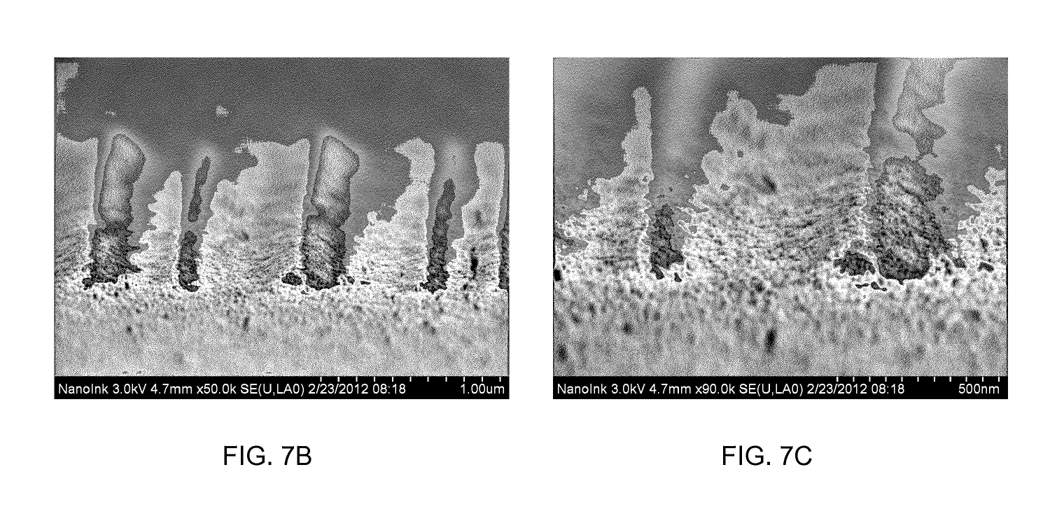

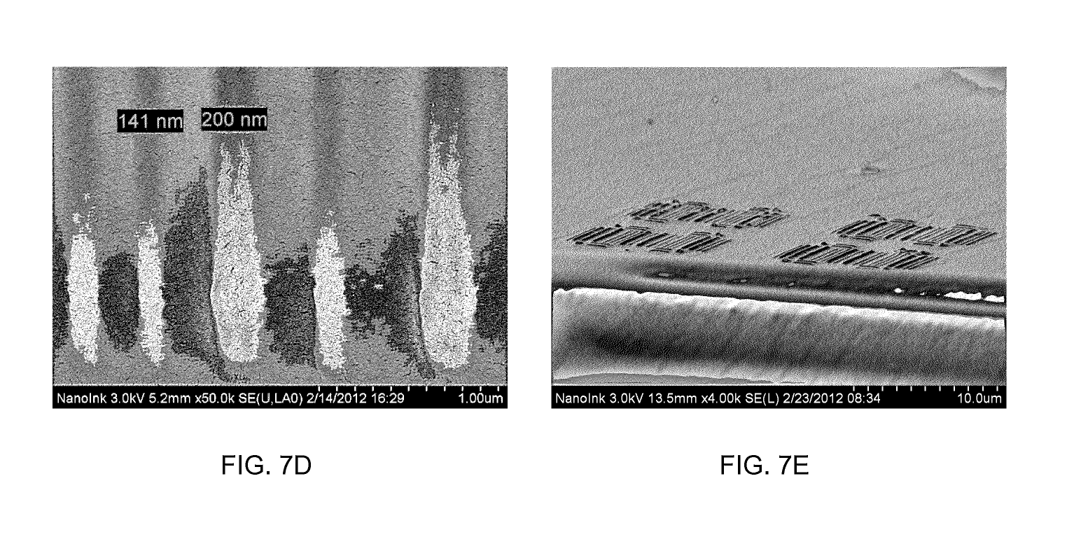

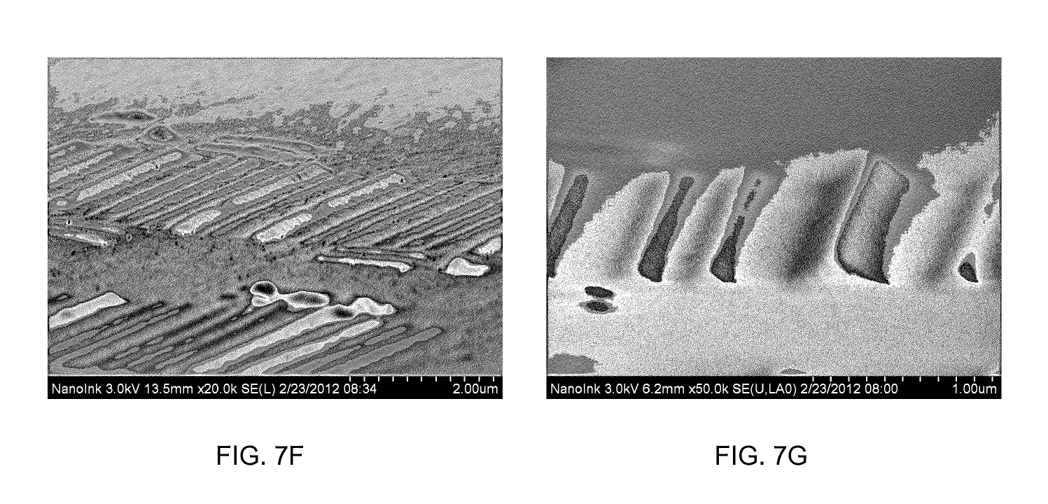

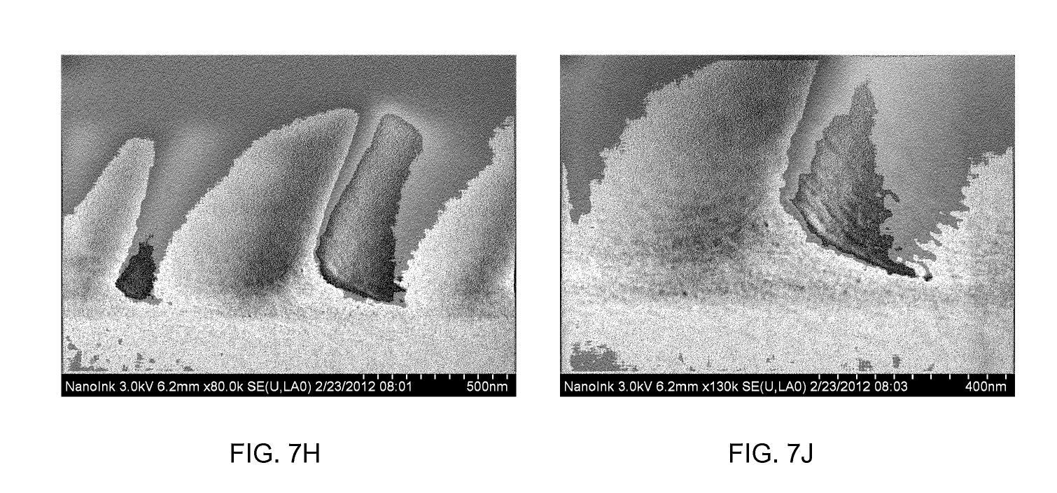

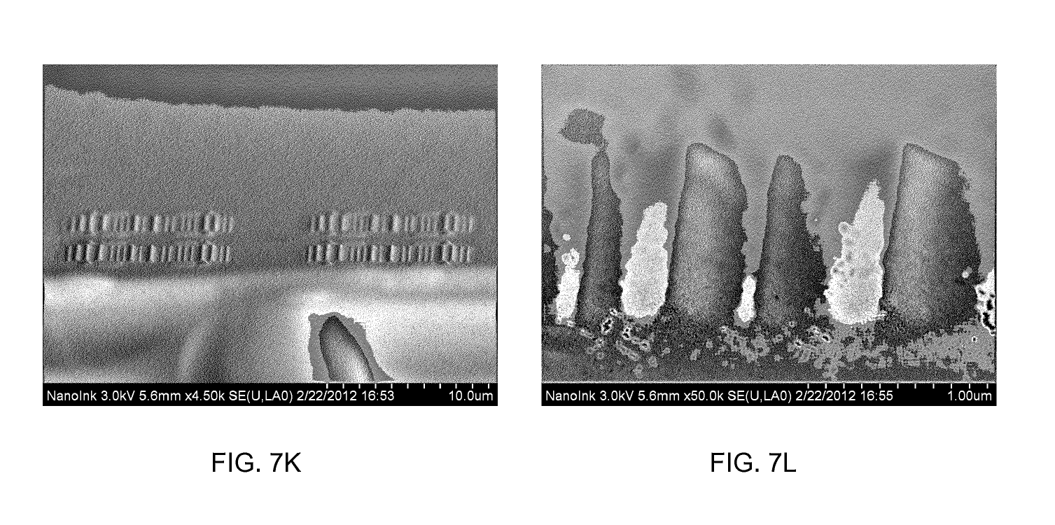

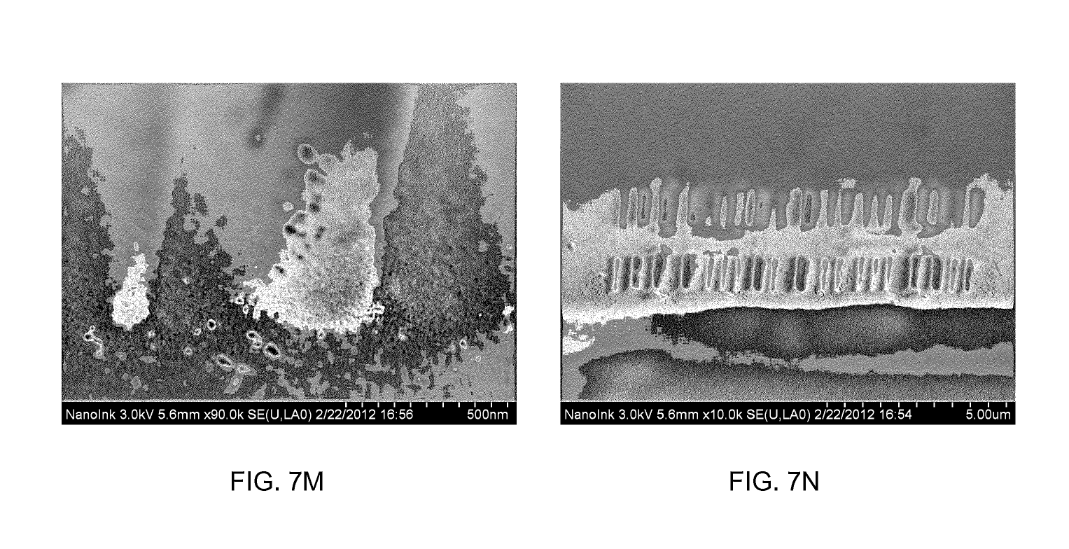

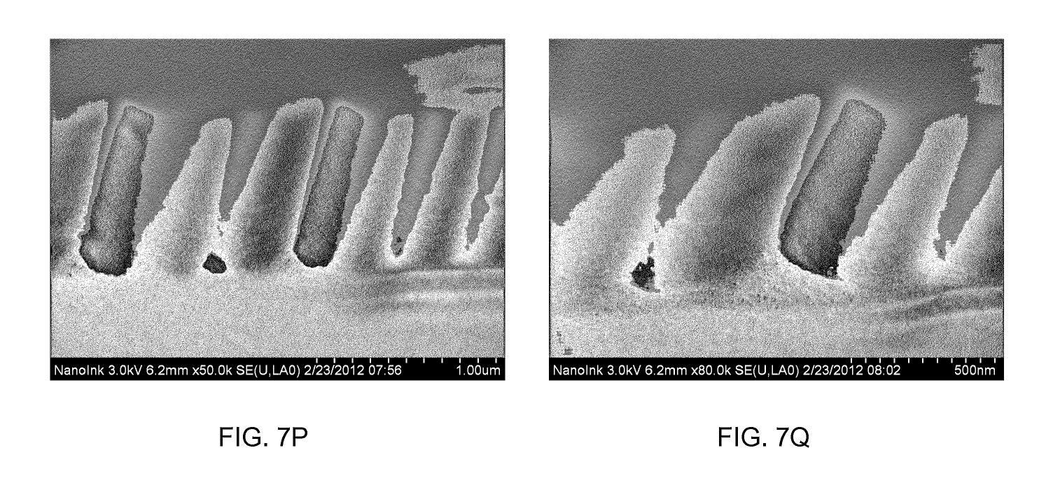

FIGS. 7A-7H, 7J-7N, and 7P-7Q are SEM images of a UV-cured epoxy replica of the identification regions of FIGS. 6A-6C.

### Example 4

### Large Bar Codes

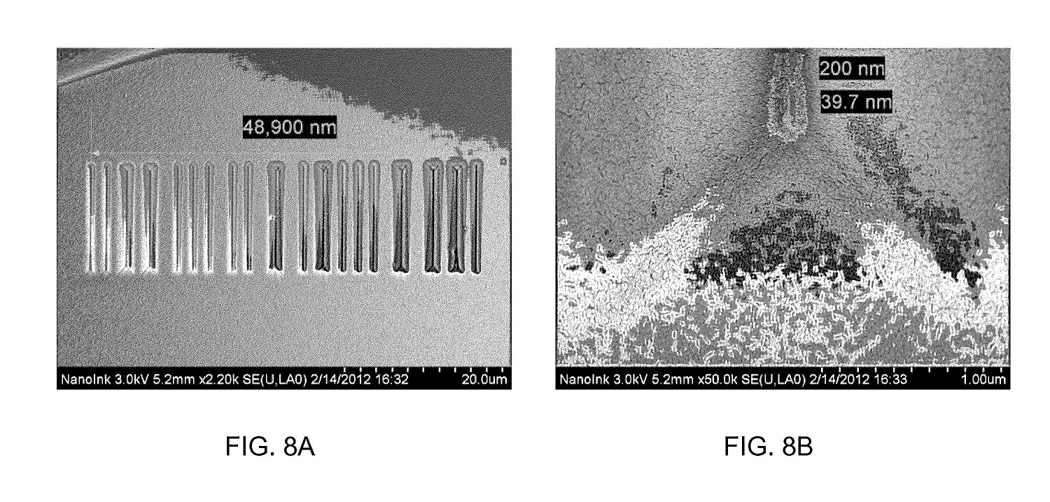

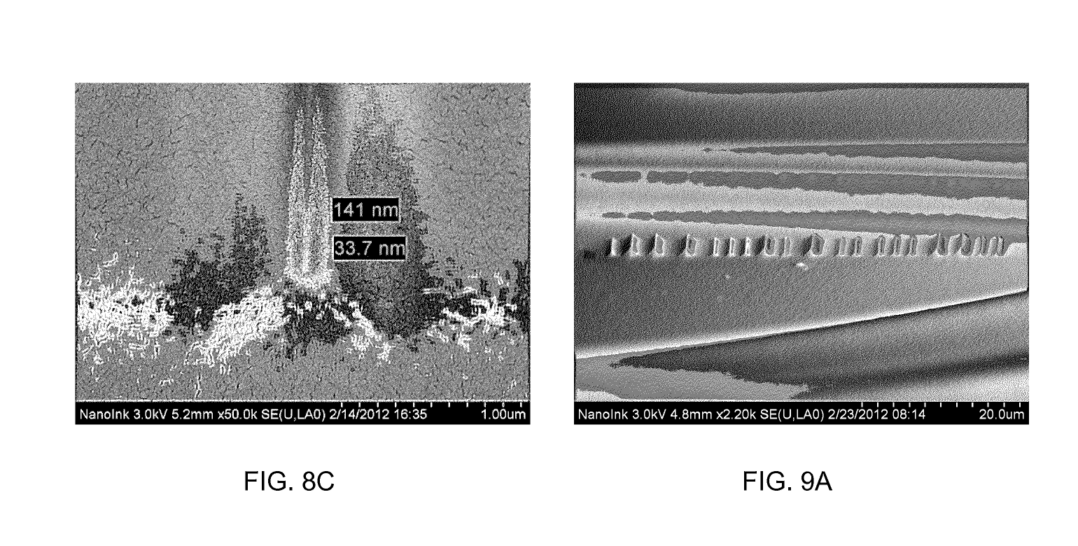

FIGS. 8A-8C are SEM images of an injection molded vial cap, showing an identification region (in this case, 49 micron long bar codes), FIG. 8A showing the whole identification region, and FIGS. 8B and 8C showing magnified views of two different identification features within the identification region. The vial cap was molded using a packing pressure of 5000 psi, injection speed of 2.0 in/sec and mold temperature of 70° F.

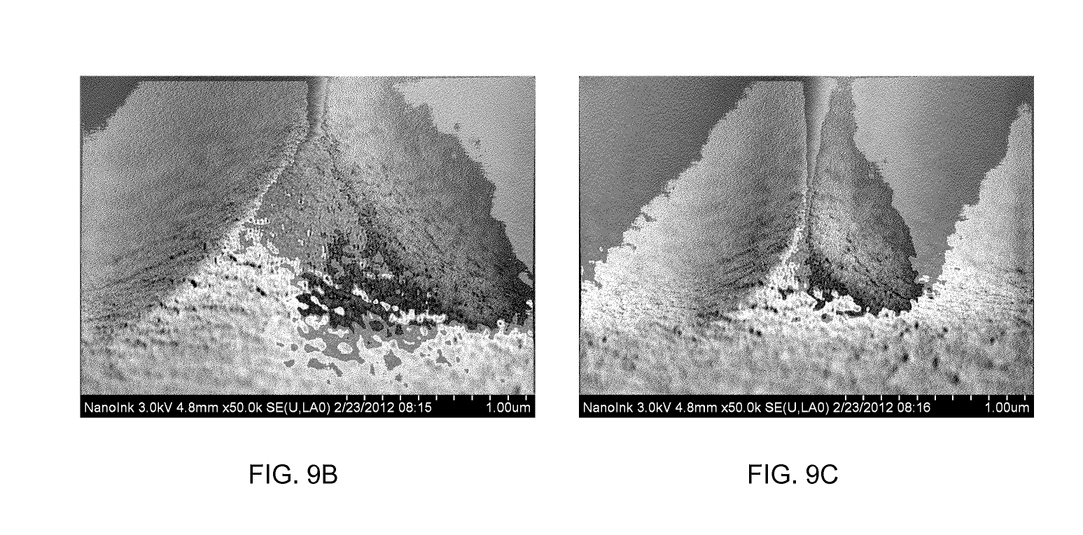

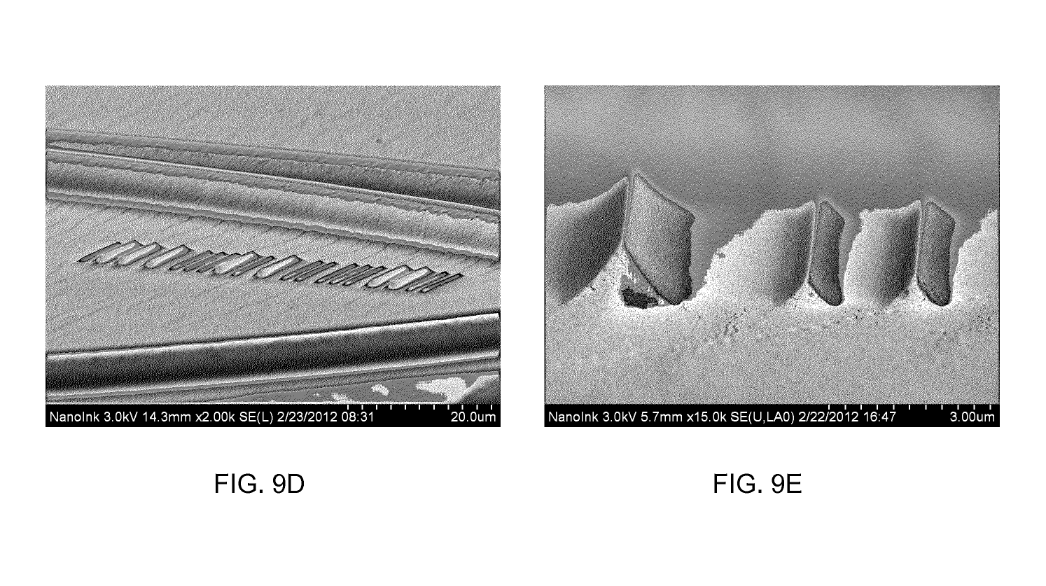

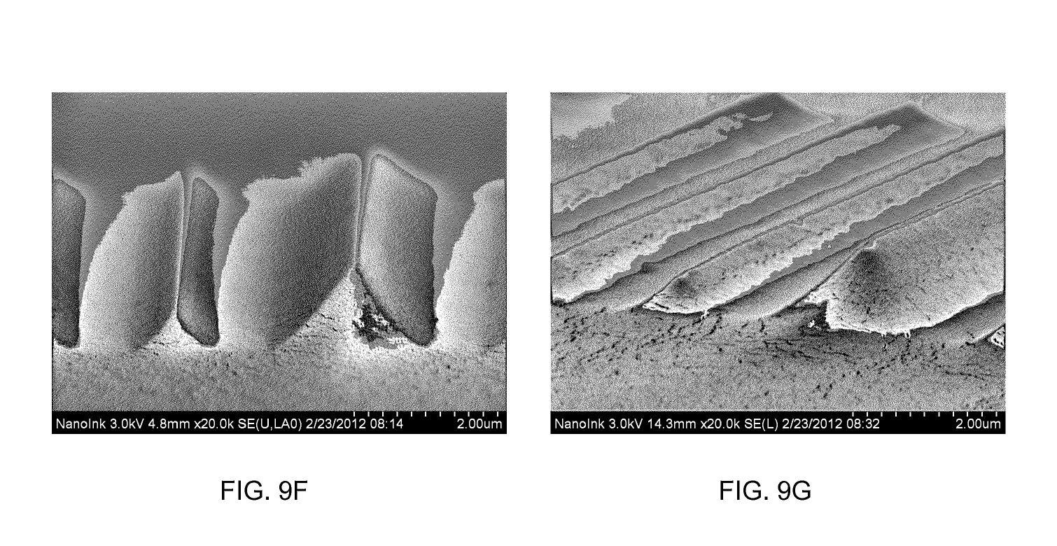

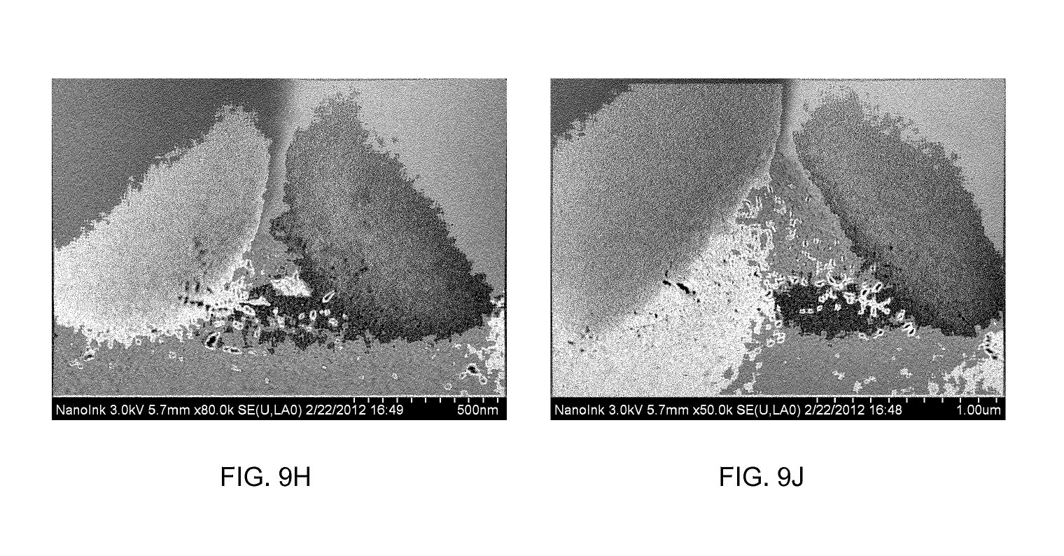

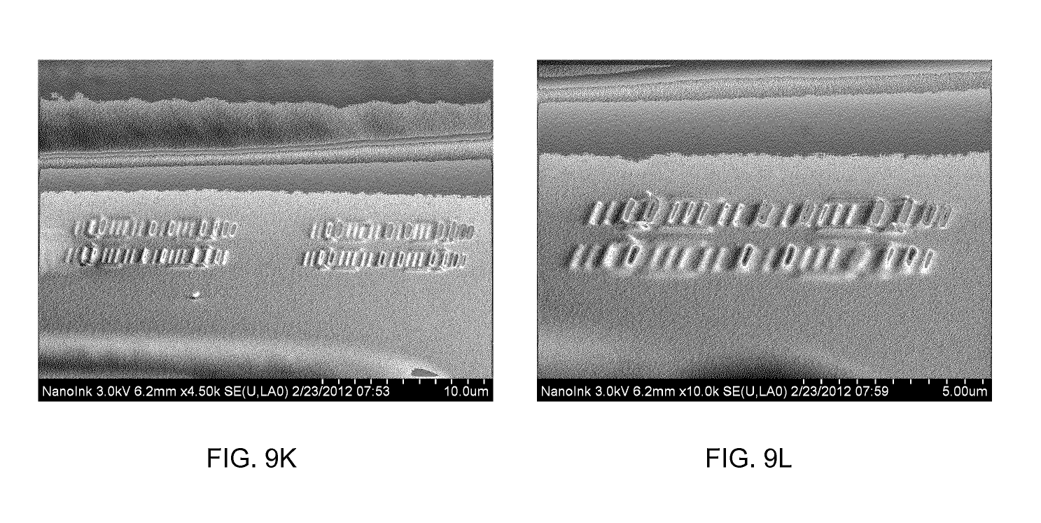

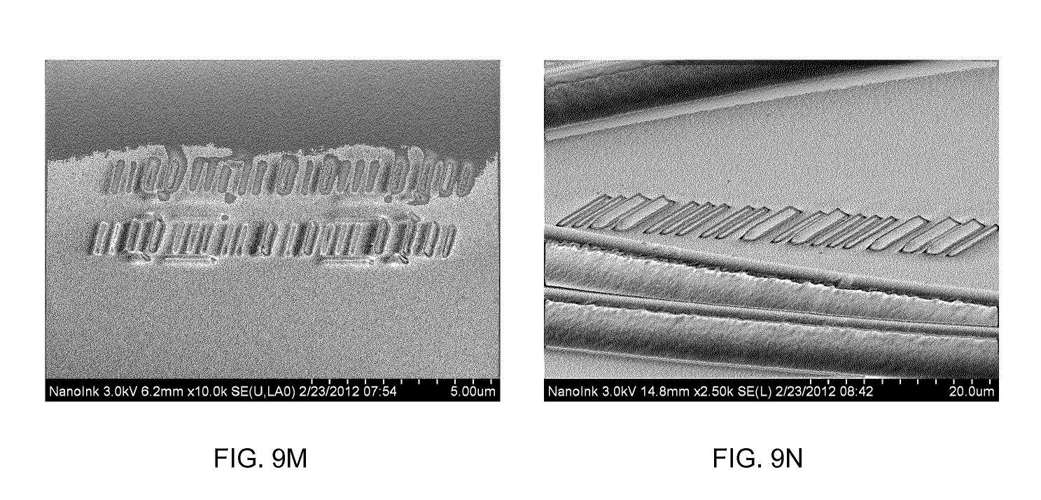

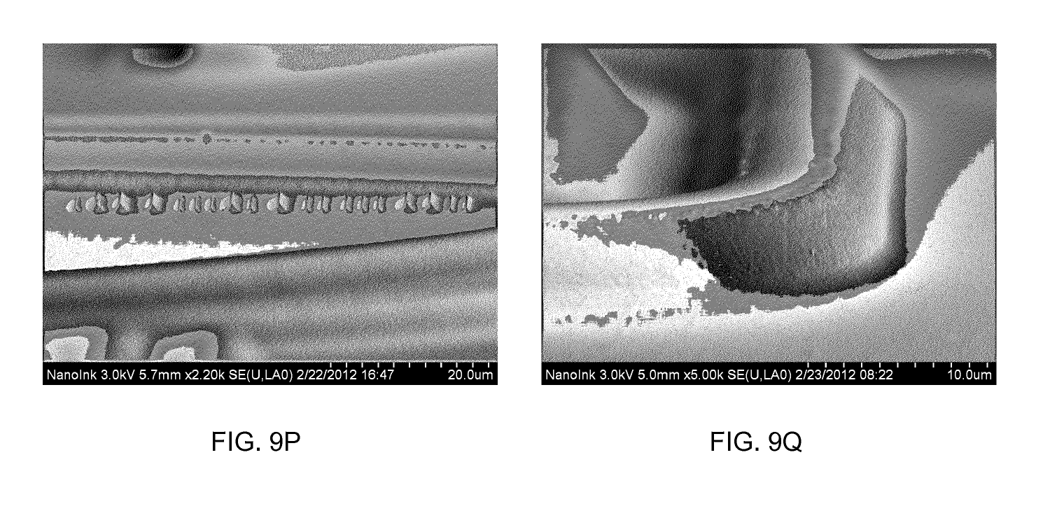

FIGS. 9A-9H, 9J-9N, and 9P-9Q are SEM images of a UV-cured epoxy replica of the molded vial cap shown in FIGS. 8A-8C.

### Example 5

### Accuracy

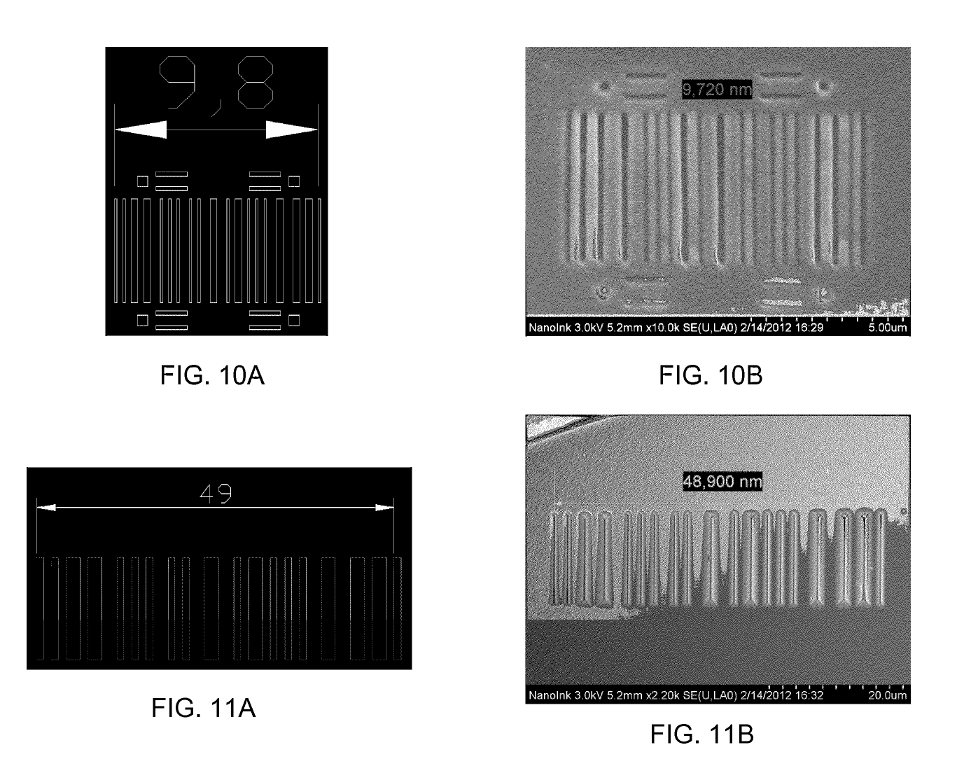

FIGS. 10A and 10B demonstrate the accuracy of reproduction of an identification region of FIGS. 6A-6C, FIG. 10A showing the original design of the identification region, and FIG. 10B showing the identification region obtained by injection molding.

FIGS. 11A and 11B demonstrate the accuracy of reproduction of an identification region of FIGS. 8A-8C, FIG. 11A showing the original design of the identification region, and FIG. 11B showing the identification region obtained by injection molding.

The vial cap was molded using a packing pressure of 5000 psi, injection speed of 2.0 in/sec and mold temperature of 70° F.

### Example 6

### Comparison of Die Types and Injection Molding Conditions

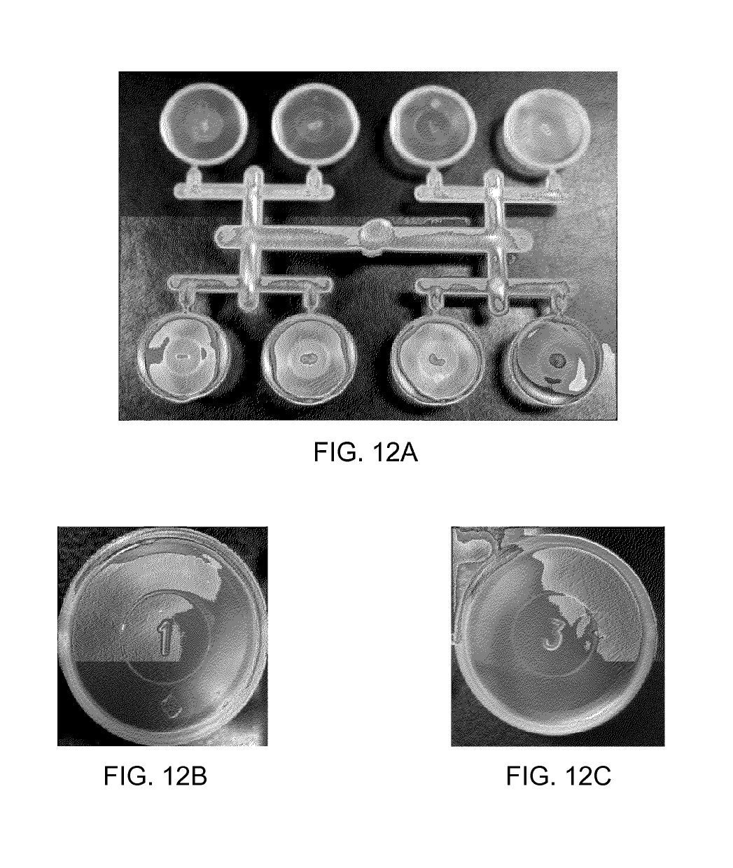

FIG. 12A is an image of a plurality of injection molded vial caps having identification regions, with runners and gates still attached; FIG. 12B is an image of an injection molded vial cap, where the die used in injection molding was a 1.5×2.0 mm die having features with a triangular cross-section; and FIG. 12C is an image of an injection molded vial cap, where the die used in injection molding was a 1×0.6 mm die having features with substantially vertical sidewall with minimal draft.

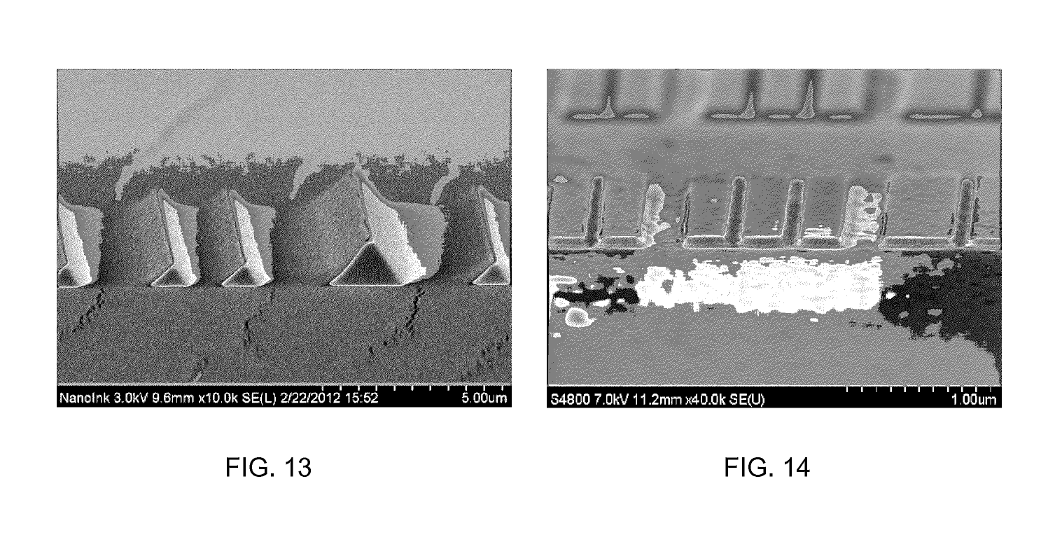

FIG. 13 is an SEM image of a portion of a UV-cured epoxy replica of an identification region (in this case, a bar code) located on an injection molded vial cap, where the die used in injection molding was a 1.5×2.0 mm die having features with a triangular cross-section.

FIG. 14 is an SEM image of a portion of a UV-cured epoxy replica of an identification region (in this case, a bar code) located on an injection molded vial cap, where the die used in injection molding was a 1×0.6 mm die having features with substantially vertical sidewall with minimal draft.

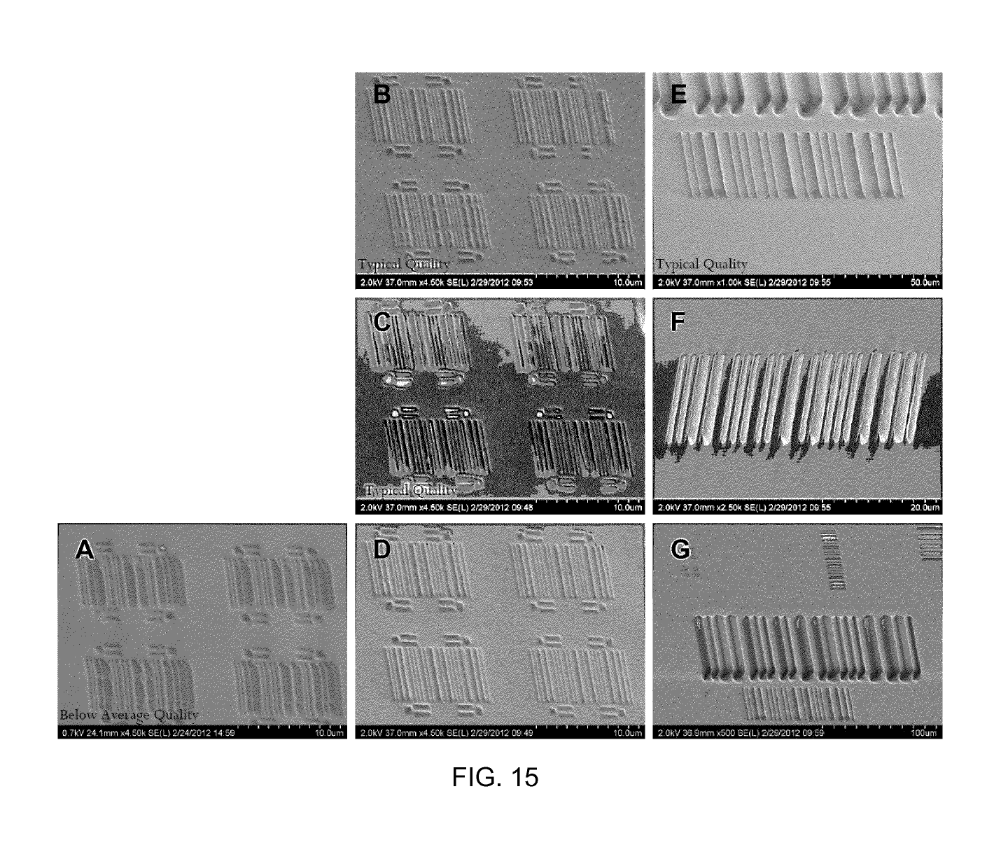

FIGS. 15A-15H and 15J are SEM images of a various portions of an identification region or regions located on an injection molded vial cap, where the die used in injection molding was a 1.5×2.0 mm die having features with a triangular cross-section, and standard injection molding conditions were used (injection speed of 2.5 in/sec, packing pressure of 5000 psi, mold temperature of 70° F.). This configuration is termed High Draft Angle Group A.

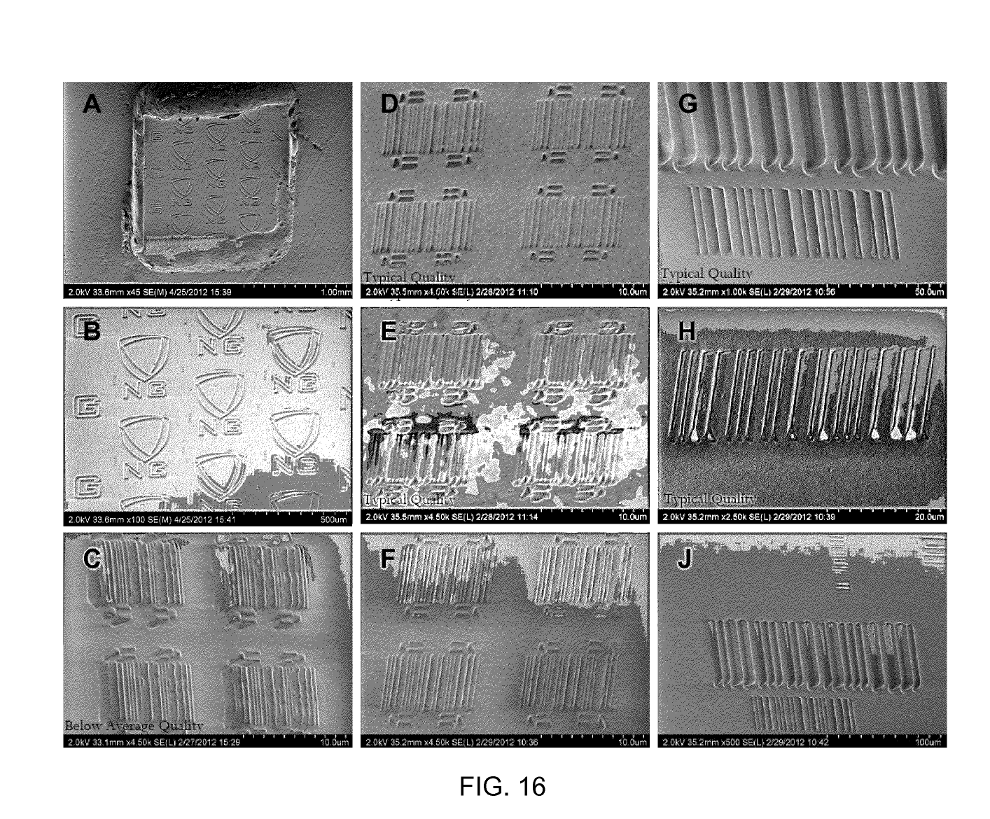

FIGS. 16A-16H and 16J are SEM images of various portions of an identification region or regions located on an injection molded vial cap, where the die used in injection molding was a 1.5×2.0 mm die having features with a triangular cross-section, and, during injections molding, the injection speed was 1.0 in/sec, packing pressure was 1000 psi, and mold temperature was 70° F. This configuration is termed High Draft Angle Group B.

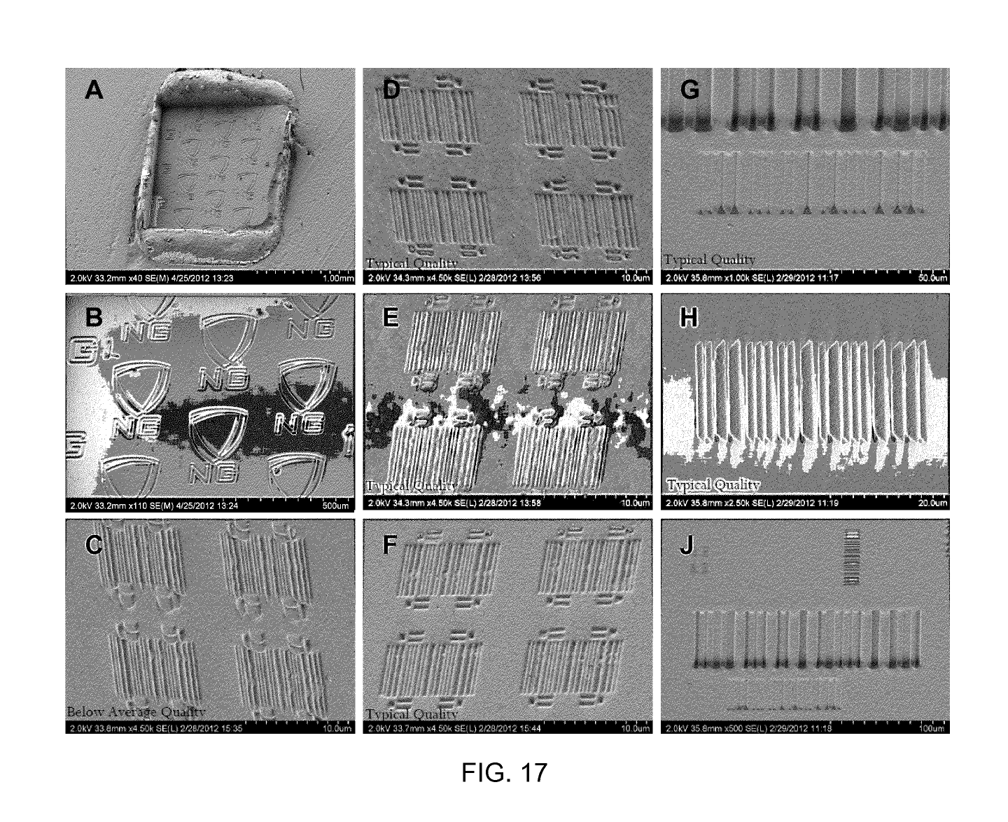

FIGS. 17A-17H and 17J are SEM images of various portions of an identification region or regions located on an injection molded vial cap, where the die used in injection molding was a 1.5×2.0 mm die having features with a triangular cross-section, and, during injections molding, the injection speed was 4.0 in/sec, packing pressure was 6000 psi, and mold temperature was 120° F. This configuration is termed High Draft Angle Group C.

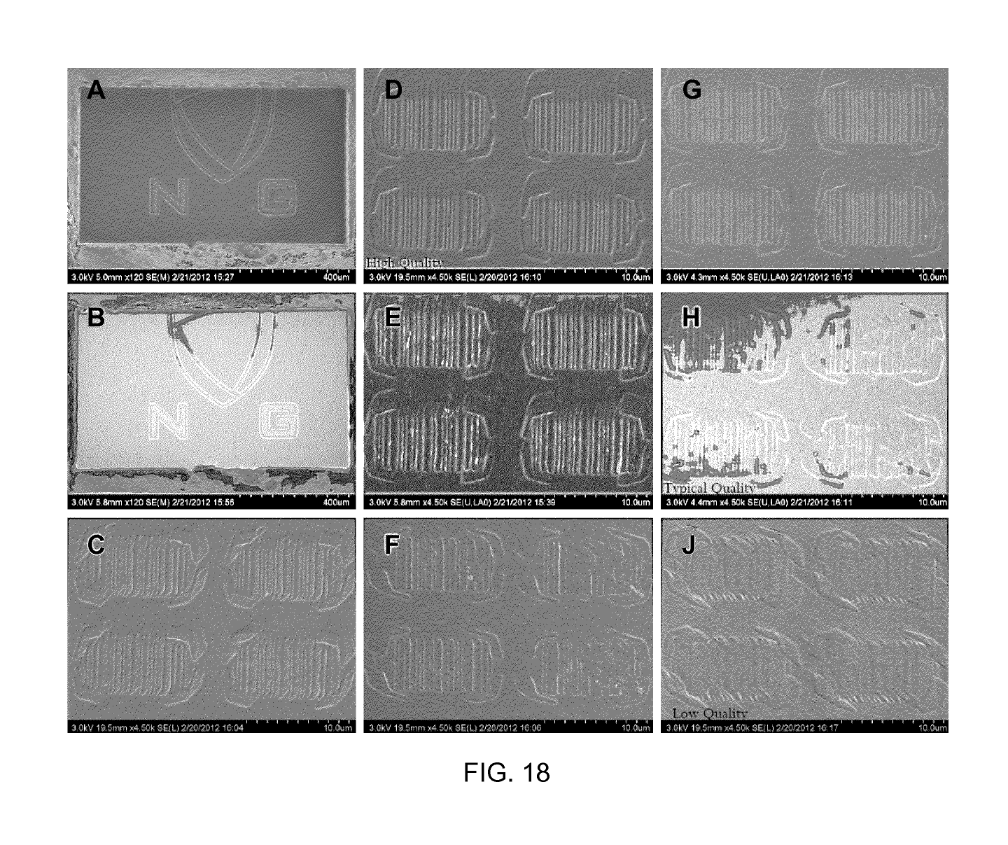

FIGS. 18A-18H and 18J are SEM images of a various portions of an identification region or regions located on an injection molded vial cap, where the die used in injection molding was a 1×0.6 mm die having features with substantially vertical sidewall with minimal draft, and standard injection molding conditions were used (injection speed of 2.5 in/sec, packing pressure of 5000 psi, mold temperature of 70° F.). This configuration is termed Low Draft Angle Group A.

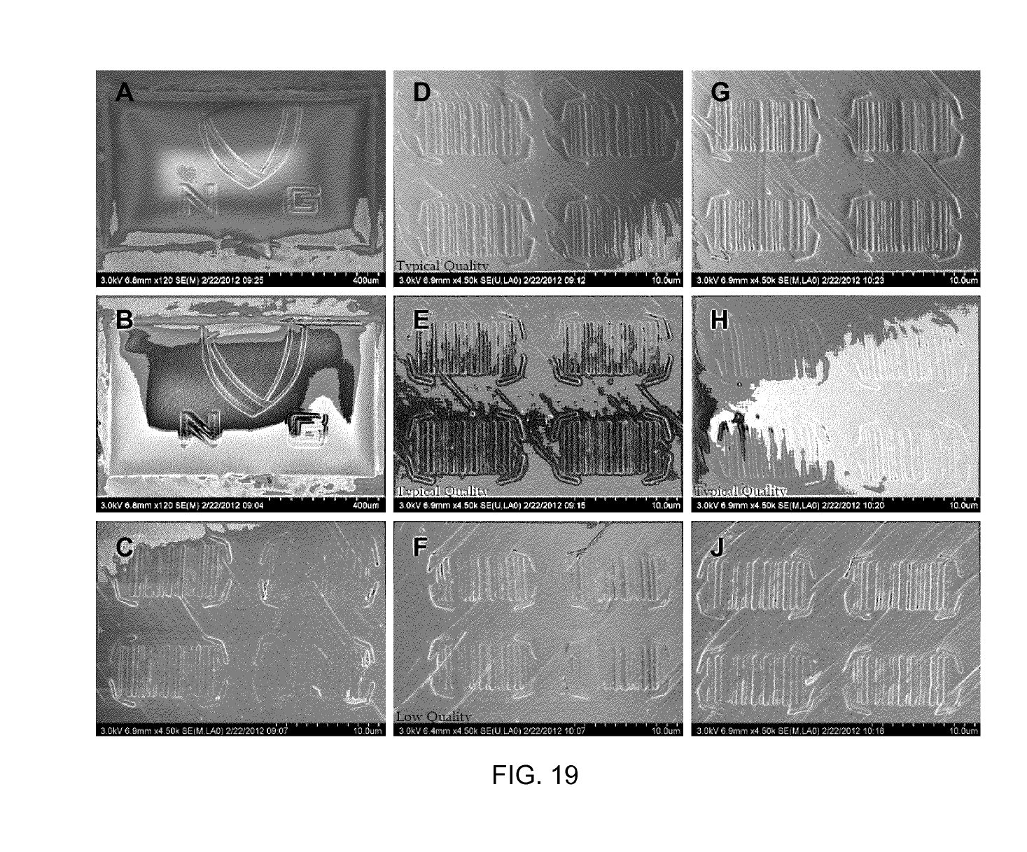

FIGS. 19A-19H and 19J are SEM images of various portions of an identification region or regions located on an injection molded vial cap, where the die used in injection molding was a 1×0.6 mm die having features with substantially vertical sidewall with minimal draft, and, during injections molding, the injection speed was 1.0 in/sec, packing pressure was 1000 psi, and mold temperature was 70° F. This configuration is termed Low Draft Angle Group B.

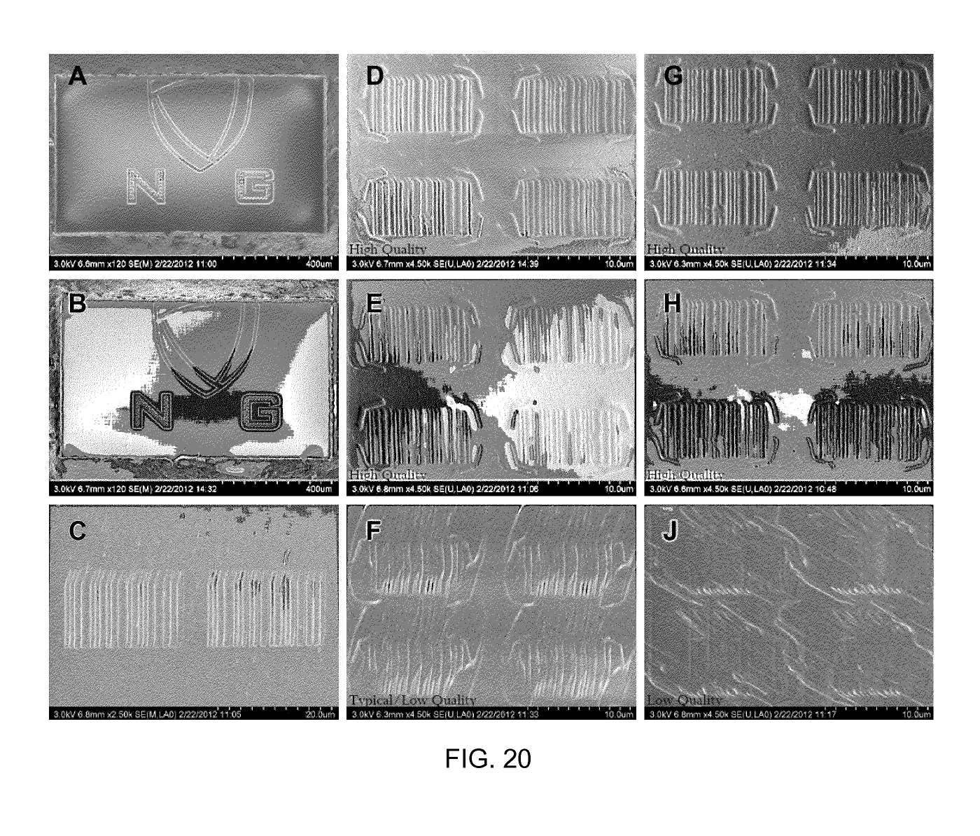

FIGS. 20A-20H and 20J are SEM images of various portions of an identification region or regions located on an injection molded vial cap, where the die used in injection molding was a 1×0.6 mm die having features with substantially vertical sidewall with minimal draft, and, during injections molding, the injection speed was 4.0 in/sec, packing pressure was 6000 psi, and mold temperature was 120° F. This configuration is termed Low Draft Angle Group C.

Before performing these experiments, it was expected that the best results would be yielded when the injection speed was 4.0 in/sec packing pressure was 6000 psi, and mold temperature was 120° F. based on the understanding of plastic flow and assumptions that a higher mold temperature and higher speed will keep plastic fluid for longer and high packing pressure will allow plastic to completely fill up the nano scale features. Surprisingly, this was not the case. For purposes of these experiments, the quality of results was measured by determining the number of bar codes that were readable on the injection molded parts. The results of these experiments are summarized in Table 1.

TABLE 1

| | Low Draft Angle | | High Draft Angle | |
|---|---|---|---|---|
| | Average # | Average % | Average # | Average % |
| Group | Readable | Readable | Readable | Readable |
| Group A | 6 | 17% | 23 | 64% |
| Group B | 23 | 64% | 31 | 86% |
| Group C | 5 | 13% | 29 | 81% |

Surprisingly, the highest barcode readability of 86% was obtained where the die used in injection molding had features with high draft angle (i.e., where the die used in injection molding, and thus the finished part, had identification features with a triangular cross-section), and, during injections molding, the injection speed was 1.0 in/sec, packing pressure was 1000 psi, and mold temperature was 70° F. Thus, in preferred embodiments, the die or mold used in injection molding is made with identification features that protrude from the die, the features being formed have a high draft angle as shown in FIG. 13. This results in the identification features on the injection molded part being recessed and having a triangular cross section.

TABLE 2

| | Die | Injection | Packing | Mold | |
|---|---|---|---|---|---|
| Feature | Protrusion | Speed | Pressure | Temperature | Average % |
| Type | (in) | (in/sec) | (psi) | (° F.) | Readable |
| Low Draft | 0.005 | 1.0 | 3000 | 70 | 64% |
| Angle | | | | | |
| High Draft | 0.005 | 1.0 | 3000 | 70 | 77% |
| Angle | | | | | |

Results in Table 1 and Table 2 indicate that the samples formed with high draft angle features (i.e., where the die used in injection molding had features with a triangular cross-section) had more readable barcodes for every group setting than samples formed with low draft angle features (i.e., where the die used in injection molding had features with substantially vertical sidewall, such as rectangular features). Without being bound by theory, it is speculated that the triangular features likely allow for improved packing and feature formation over rectangular features during injection molding. In other words, the plastic can flow more easily between the triangular features than the densely packed, rectangular features. It is also believed that plastic being pushed through the channels between rectangular features causes streaking or smearing. Therefore, it is preferred that the identification features have a triangular cross section (taken in a direction perpendicular to the direction it which the features extend).

### Nano-Molding for Transparent Container Portions

Nano-molding can be performed on a container interior for transparent container components, which can have a visible inner surface. This can be very useful for anti-counterfeiting purposes. In one embodiment, only overt (logo) features are used that will be seen with a basic authentication kit. They can be protected from environmental effects.

Detection can be made using a reflected light, or light transmission if the container portion is transparent or disassembled.

Other Objects and Compositions with Identification Features

In general, the various embodiments disclosed herein can be applied to pharmaceutical goods which are susceptible to counterfeiting, including for example high priced pharmaceuticals, prescription drugs, and blockbuster drugs with large sales volume, wherein price differentials exist from country to country and the economic incentive to counterfeit is high, as described above. The description above for pharmaceutical container portions, and methods of making, generally can be also adapted to apply to other objects which can be subjected to counterfeiting fraud such as inhalers, confectionary compositions, consumer goods like CDs or DVDs, and other electronic media, microelectronics (such as microchips, and housings), micro-optic devices, sensors, automotives, medical devices, aircraft, an industrial component such as a wind turbine blade, consumer appliances, a piece of sports equipment, contact lenses, and other industries where parts or components are highly counterfeited.

Hence, the embodiments disclosed herein also relate to objects and compositions which have a surface, wherein the surface comprises at least one identification region having at least one identification feature. An object broadly can be a variety of items including items of commerce and is not particularly limited by any shape or form. It can be man-made or natural. Typically, an object can have a particular use or function and can comprise one or many compositions. A composition also broadly can be a variety of materials, chemical compounds, elements, mixtures, blends, composites, metals, glasses, polymers, ceramics, and the like and is not limited by a particular use or function. The identification feature on the object or composition can have relatively small lateral and vertical dimensions. The feature can be a positive feature, protruding from the surface, or a negative feature, extending into the surface.

Preferred examples of objects include consumer products, entertainment media, compact disks, DVDs, disk drive heads, semiconductor chips, integrated circuits and their components, and packaging containers. In particular, syringes, pre-loaded syringes, vaccines and vaccine vials, and injectable drug vials, including bottle seal, rubber stoppers, medical devices including catheters and implantable devices, and packaging labels can be used. In general, objects which are susceptible to counterfeiting or copying are particularly of use.

### EXCLUSIONARY EMBODIMENTS

Embodiments of the present invention may specifically exclude typical injection molding. For example, in one embodiment, a method comprises providing a mold comprising a surface with at least one identification region, the at least one identification region comprising at least one identification feature that has a lateral dimension of 100 microns or less; and molding an item from a moldable material using the mold, such that the at least one identification region is transferred to a surface of the item, wherein the molding is performed using a method other than typical injection molding. Methods other than typical injection molding include reaction injection molding, compression molding, metal injection molding, thermoforming, co-injection molding, fiber-loaded injection molding, gas-assisted injection molding, and rubber injection molding.

What is claimed is:

1. A method comprising:
providing a mold comprising a surface with at least one identification region, the at least one identification region comprising at least one identification feature that has a lateral dimension of 100 microns or less; and
molding an item from a moldable material using the mold, such that the at least one identification region is transferred to a surface of the item,
wherein the molding is performed using one of the techniques selected from the group consisting of reaction injection molding, compression molding, metal injection molding, thermoforming, co-injection molding, fiber-loaded injection molding, gas-assisted injection molding, and rubber injection molding.

2. The method according to claim 1, wherein the mold comprises a removable insert, and wherein the removable insert comprises the surface with the at least one identification region.

3. The method according to claim 1, wherein the at least one identification comprises two or more identification regions.

4. The method according to claim 1, wherein the at least one identification feature has a height smaller than about 100 microns.

5. The method according to claim 1, wherein the at least one identification feature has a height smaller than about 1 micron.

6. The method according to claim 1, wherein the lateral dimension is smaller than about 1 micron.

7. The method according to claim 1, wherein the at least one identification feature comprises an indentation in the surface of the mold.

8. The method according to claim 1, wherein the at least one identification feature comprises a protrusion on the surface of the mold.

9. The method according to claim 1, wherein the at least one identification region comprises a barcode.

10. The method according to claim 1, wherein the at least one identification region comprises a moiré pattern.

11. The method according to claim 1, wherein the moldable material comprises a polymer.

12. The method according to claim 1, wherein the item comprises a pharmaceutical bottle, a pharmaceutical vial cap, a rubber stopper, a syringe barrel, a syringe plunger, or an inhaler.

13. The method according to claim 1, wherein the mold comprises a removable insert, and wherein the removable insert comprises the surface with the at least one identification region, the method further comprising replacing the insert.

14. The method according to claim 1, wherein the at least one identification feature has a height smaller than about 100 nm.

15. The method according to claim 1, wherein the at least one identification feature is a covert identification feature.

16. The method according to claim 1, wherein the moldable material is an epoxy.

17. The method according to claim 1, wherein the moldable material is a thermoplastic material.

18. The method according to claim 1, wherein the moldable material is a thermosetting material.

19. The method according to claim 1, wherein the moldable material is a composite material.

20. The method according to claim 1, wherein the moldable material is a metal.

21. The method according to claim 2, wherein the removable insert comprises a die that is disposed within a recess located in a portion of the removable insert, wherein the die comprises the surface with the at least one identification region.

22. The method according to claim 21, wherein edges of the die are flush with a surface of the removable insert surrounding the die.

23. The method of claim 1, wherein the surface comprises at least ten of the same identification regions.

24. The method of claim 1, wherein the surface comprises at least 100 of the same identification regions.

25. The method of claim 1, wherein the at least one identification region comprises a diffraction grating.

26. The method of claim 25, wherein the diffraction grating is configured to provide a form birefringence effect.

27. The method of claim 25, wherein the diffraction grating is configured to provide an anti-reflection effect.

28. The method of claim 25, wherein the diffraction grating is configured to provide an interference effect.

29. The method of claim 25, wherein the moldable material is a transparent material, and the diffraction grating is configured to provide a dot pattern when laser light is shined through the diffraction grating.

30. The method of claim 25, further comprising:
creating a replica of the diffraction grating out of a transparent material, wherein the replica is configured to provide a dot pattern when laser light is shined through the diffraction grating of the replica.

31. The method of claim 25, wherein the diffraction grating is configured to provide a color change when light of a predetermined wavelength is irradiated onto the diffraction grating.

32. The method of claim 1, wherein the at least one identification region comprises a logo.

33. The method of claim 1, wherein the at least one identification region comprises a bar code having an overall length of less than 100 microns.

34. The method of claim 33, wherein the at least one identification feature has a lateral dimension of 10 microns or less.

35. The method of claim 1, wherein the at least one identification region comprises a bar code having an overall length of less than 10 microns.

36. The method of claim 35, wherein the at least one identification feature has a lateral dimension of 1 micron or less.

37. The method of claim 1, wherein the at least one identification feature has a triangular cross section.

38. The method of claim 1, wherein the item is a confectionary composition, a CD, a DVD, a microelectronic device, a micro-optic device, a sensor, an automotive device, a medical device, an aircraft component, a piece of sports equipment, a wind turbine, a consumer appliance, or a contact lens.

39. A method comprising:
providing a mold comprising a surface with at least one identification region, the at least one identification region comprising at least one identification feature that has a lateral dimension of 100 microns or less; and
molding an item from a moldable material using the mold, such that the at least one identification region is transferred to a surface of the item,
wherein the molding material is a thermosetting material or a composite material.

40. The method of claim 39, wherein the molding material comprises vulcanizable rubber, a phenol-formaldehyde resin, a fiber reinforced polymer, urea-formaldehyde foam, melamine resin, a polyimide, a cyanate ester, a polycyanurate, a carbon fiber layup with resin, a fiberglass layup with resin, or a curable epoxy.

41. The method of claim 39, wherein the molding material is an epoxy.

42. The method of claim 39, wherein the molding material is a UV curable epoxy.

43. A method comprising:
providing a mold comprising a removable insert, wherein the removable insert comprises a die that is disposed within a recess located in a portion of the removable insert, the die comprising a surface with at least one identification region, the at least one identification region comprising at least one identification feature that has a lateral dimension of 100 microns or less; and
molding an item from a moldable material using the mold, such that the at least one identification region is transferred to a surface of the item,
wherein edges of the die are flush with a surface of the removable insert surrounding the die.

44. The method of claim 43, wherein the molding is injection molding.

45. A method comprising:
providing a mold comprising a surface with at least one diffraction grating, the at least one diffraction grating comprising at least one feature that has a lateral dimension of 10 microns or less; and
injection molding an item from a moldable material using the mold, such that the at least one diffraction grating is transferred to a surface of the item.

46. The method of claim 45, wherein the diffraction grating is configured to provide a form birefringence effect.

47. The method of claim 45, wherein the diffraction grating is configured to provide an anti-reflection effect.

48. The method of claim 45, wherein the diffraction grating is configured to provide an interference effect.

49. The method of claim 45, wherein the moldable material is a transparent material, and the diffraction grating is configured to provide a dot pattern when laser light is shined through the diffraction grating.

50. The method of claim 45, further comprising:
creating a replica of the diffraction grating out of a transparent material, wherein the replica is configured to provide a dot pattern when laser light is shined through the diffraction grating of the replica.

51. The method of claim 45, wherein the diffraction grating is configured to provide a color change when light of a predetermined wavelength is irradiated onto the diffraction grating.

52. The method of claim 45, wherein the at least one feature has a lateral dimension of 10 microns or less.

53. The method of claim 45, wherein the at least one feature has a lateral dimension of 1 micron or less.

54. The method of claim 45, wherein the at least one feature has a triangular cross section.

55. A method comprising:
providing a mold having a surface, the surface comprising:
at least one identification region, the at least one identification region comprising at least one identification feature that has a lateral dimension of 100 microns or less, and
a plurality of overt features that simulates a natural surface roughness and texture of the mold so as to camouflage the existence of the at least one identification region; and
injection molding an item from a moldable material using the mold, such that the at least one identification region and the plurality of overt features are transferred to a surface of the item.

56. A method comprising:
providing a mold comprising a surface with at least one identification region, the at least one identification region comprising at least one identification feature that has a lateral dimension of 100 microns or less; and
injection molding an item from a moldable material using the mold, such that the at least one identification region is transferred to a surface of the item, wherein the at least one identification feature has a triangular cross section.
